(19) United States
(12) Patent Application Publication
(10) Pub. No.: US 2021/0339417 A1
(43) Pub. Date: Nov. 4, 2021

(54) CONNECTION SYSTEM FOR SAFETY RAZORS

(71) Applicant: BEIERSDORF AKTIENGESELLSCHAFT, Hamburg (DE)

(72) Inventors: Peter MAURER, Neumuenster (DE); Alexander KRUEMKE, Hamburg (DE); Michaela KOHUT, Hamburg (DE); Arne SCHULTCHEN, Hamburg (DE); Andre FELDMANN, Hamburg (DE); Christine JUNG, Hamburg (DE); Armin WARNECKE, Hamburg (DE); Jelte STEUR, Oudehaske (NL); Arif VEENDIJK, Assen (NL); Sander PATJE, Groningen (NL); Johannes Rogier DE VRIND, Haren (NL)

(21) Appl. No.: 17/274,482

(22) PCT Filed: Sep. 10, 2018
(86) PCT No.: PCT/EP2018/074354

§ 371 Date: Mar. 9, 2021

(51) Int. Cl. B26B 21/52; B26B 21/22

(52) U.S. Cl. CPC B26B 21/521; B26B 21/4018; B26B 21/522; B26B 21/225

(57) ABSTRACT

A connection system for connecting a safety razor handle (50) to a replaceable blade cartridge (10), comprising: a cartridge connecting structure (120) attached to the replaceable blade cartridge (10); and a handle connecting structure (102) attached to the safety razor handle (50) and configured to be brought into engagement with the cartridge connecting structure (120) along a connection axis, wherein the handle connecting structure (102) comprises a lever (112) mounted to a body (103), the lever (112) having a user end (113) to be actuated by a user, a working end (114), and a rotation axis (115) about which the lever (112) is rotatable with respect to the body (103), the rotation axis (115) being situated between the user end (113) and the working end (114), and the working end (114) of the lever (112) is configured to exert a pushing force on the cartridge connecting structure (120) when the lever (112) is rotated by actuation of the user end (113), to eject the cartridge connecting structure (120) from the handle connecting structure (102).

### FIELD

The invention generally relates to safety razors and, more particularly, to structures for connecting a replaceable blade cartridge to a handle of such safety razors.

### BACKGROUND

Safety razors typically comprise a handle and a cartridge having a plurality of blades arranged between a guard and a cap. Some safety razors provide a mechanism to allow the user to detach the cartridge from the handle to allow replacement of the cartridge when the blades have become dulled.

### SUMMARY

One embodiment provides a connection system for connecting a safety razor handle to a replaceable blade cartridge, comprising: a cartridge connecting structure attached to the replaceable blade cartridge; and a handle connecting structure attached to the safety razor handle and configured to be brought into engagement with the cartridge connecting structure along a connection axis, wherein the handle connecting structure comprises a lever mounted to a body, the lever having a user end to be actuated by a user, a working end, and a rotation axis about which the lever is rotatable with respect to the body, the rotation axis being situated between the user end and the working end, and the working end of the lever is configured to exert a pushing force on the cartridge connecting structure when the lever is rotated by actuation of the user end, to eject the cartridge connecting structure from the handle connecting structure.

According to this connection system there is little friction between the rotating lever and the other elements of the handle connecting structure, in contrast particularly to push button-type mechanisms in which the force on the button when pushed by the user can give rise to large friction forces between the button and the handle that need to be overcome in order to release the cartridge from the handle. As a result, in this connection system a low overall force may be sufficient to eject the cartridge from the handle (i.e., the cartridge connecting structure from the handle connecting structure). This means that there may be a low variability in the force used to eject the cartridge from the handle, thereby enabling more controlled ejection of the cartridge by the user.

In addition, the provision of a rotating lever may reduce the risk of jamming, especially compared to mechanisms that utilise a sliding ‘pusher’, which typically is of a certain length in the direction of the movement relative to the direction perpendicular to the movement. The provision of a rotating lever may also provide space savings in the handle connecting structure which can be used for other components such as securing elements. Also, the lever can be actioned with a single digit only (such as the forefinger) to eject the cartridge. Thus the mechanism is safer than those that require use of two fingers, or a finger and thumb for example.

The handle connecting structure may be releasably secured to the cartridge connecting structure by complementary securing elements. These may comprise mechanical means (e.g., complementary projections, a projection and a complementary recess or hole) that may form a snap-fit, friction fit, or interference fit, magnetic means (e.g., a magnet and corresponding ferrous metal), or any other suitable means. Thus, the pushing force on the cartridge connecting structure may also release complementary securing elements of the handle and cartridge connecting structures. However, the handle and cartridge connecting structures may be provided with complementary securing elements that may be released by a separate force, i.e., a separate action from the rotating of the lever by the user.

Friction between the working end of the lever and a generally flat inner surface of the cartridge connecting structure when the lever is rotated may be sufficient to eject the cartridge connecting structure from handle connecting structure. However, to aid in the ejection of the cartridge connecting structure from the handle connecting structure, an inner surface of the cartridge connecting structure may be provided with a protrusion (e.g., a rib) against which the working end of the lever urges when the lever is rotated by actuation of the user end.

The pushing force may be exerted directly on the cartridge connecting structure by the working end of the lever, i.e., without any intermediate element between the working end of the lever and the cartridge connecting structure. The pushing force may deform a wall of the cartridge connecting structure. This deformation may cause the complementary securing elements of the handle and cartridge connecting structures to disengage. The wall of the cartridge connecting structure may return to its original shape once the pushing force ceases to be applied, i.e., the wall may be elastically deformed with little or no permanent deformation, so that the cartridge may be re-attached. Alternatively the cartridge connecting structure may be permanently deformed. The working end of the lever need not deform the cartridge connecting structure, and instead the working end of the lever may engage a protrusion, recess, or hole of the cartridge connecting structure to convert rotating movement into linear motion.

The lever may be mounted to the body so that the user end is to be actuated in a direction toward the handle, i.e., in a direction opposite to that in which the handle connecting structure is brought into engagement with the cartridge connecting structure. This means that the space between the handle and the user end of the lever can be for the ‘travel’ of the user end. The space for the finger of the user to reach the user end of the lever is on the cartridge side on which more space may be available, e.g., to allow pivoting of the cartridge. Thus, the connecting system may have a compact form factor that allows it to fit into a relatively small ‘neck’ area between the handle and the cartridge, yet still enables the user to easily actuate the lever.

The lever may be rigid and may be any suitable shape(s), e.g., straight, bent, or curved. A straight lever is one in which the user end and the working end are in the same generally straight line. Straight levers provide a simple construction for converting a rotation into a linear motion. The working end of the lever is the portion of the lever that performs the function of pushing against the cartridge connecting structure. It may have a chamfered surface. Such a shape may provide a greater contact area between the working end of the lever and the cartridge connecting structure. This may aid in converting the rotation of the lever into a displacement (ejection) of the cartridge connecting structure.

The working end of the lever may comprise a pair of arms, each arm having a contact portion with a contact surface, and each arm being joined to the user end of the lever at the rotation axis. This allows contact forces between the working end of the lever and the cartridge connecting structure to be distributed over a plurality of surfaces or over a greater surface area.

For example, the user end may be C-, U- or V-shaped, with the arms of the working end extending from the tips of C, U or V. Alternatively, the arms of the working end may be offset either inwardly or outwardly of the user end in directions along the rotation axis. Thus, each arm may further have a bearing portion with a bearing surface, and the user end may have bearing portions which are respectively joined to the bearing portions of the working end at the rotation axis, the bearing portions of the user end having bearing surfaces which face in an opposite direction to the bearing surfaces of the working end. This allows contact forces between the lever and the handle connecting structure to be distributed over a plurality of surfaces or over a greater surface area.

The body of the handle connecting structure may comprise a housing and a cover, which may be snap fit together around the lever to form a closed package. The bearing portions of the user end and the bearing portions of the working end may be sandwiched between the housing and the cover of the body, with the bearing surfaces of the user end configured to bear against an inner surface of the housing, and with the bearing surfaces of the working end configured to bear against an inner surface of the cover. Since all parts are sandwiched between other parts or snapped together, the handle connecting structure can be easily stored and transported prior to assembly with the handle.

The working end of the lever may be configured to contact the cartridge connecting structure when the cartridge connecting structure is brought into engagement with the handle connecting structure, to rotate the lever into a position ready for actuation by the user. Thus, when a new cartridge is attached to the handle the lever will return to its ‘ready’ position. In this position the user end of the lever may be inclined away from the handle.

The handle connecting structure may include a biasing spring to maintain the position of the lever and prevent ‘rattling’ of the lever when the cartridge connecting structure is not attached to the handle connector structure. Alternatively, or in addition, the lever may have one or more protrusions configured to generate friction against the body of the handle connecting structure. A relatively small amount of friction between the lever and the body may be sufficient to prevent rattling of the lever, and is easy to overcome when the user actuates the user end of the lever. The biasing spring may therefore be eliminated to keep the design simple and the number of components to a minimum.

The cartridge connecting structure may comprises a pair of legs extending outwardly from a body and forming a pivoting connection to a blade unit of the replaceable blade cartridge, the body of the cartridge connecting structure having a pair of holes adjacent to the pair of legs and configured to receive a pair of protrusions extending from the body of the handle connecting structure.

The user end of the lever may have a chamfered surface so that the side of the user end facing the handle extends further than the side of the user end facing away from the handle. This configuration helps to direct the user towards the intended use of the lever, i.e., to pull the lever towards the handle.

The handle connecting structure and the handle body may be permanently attached to one another so that they are not detachable during normal use. However, they may be individually manufactured and then assembled together. Similarly, the cartridge connecting structure may be permanently attached to the cartridge so that they are not detachable during normal use, but may be individually manufactured and then assembled together.

Another embodiment provides a handle connecting structure for a safety razor handle, comprising: a body configured to be attached to the safety razor handle; and a lever mounted to the body, the lever having a user end to be actuated by a user, a working end, and a rotation axis about which the lever is rotatable with respect to the body, the rotation axis being situated between the user end and the working end, wherein when the handle connecting structure is engaged with a cartridge connecting structure of a replaceable blade cartridge and the lever is rotated by actuation of the user end, the working end of the lever is configured to exert a pushing force on the cartridge connecting structure to eject the cartridge connecting structure from the handle connecting structure.

Another embodiment provides a safety razor handle, comprising: a handle body; and a handle connecting structure according to any of the definitions above.

The handle connecting structure may be attached to the handle body via an insert in the handle body.

The handle body may comprises an underneath surface portion facing the skin of the user in use and comprising an attachment means for attachment to a blade unit; a front surface portion facing in the opposite direction from the shaving direction in use; a rear surface portion facing in the shaving direction in use; a top surface portion and side surface portions, one directed to either side of the blade length in use; wherein the top surface portion, underneath surface portion and side surface portions together form a continuous smooth surface which is a substantially cylindrical or substantially ellipsoid or substantially partially spherical surface; and wherein: the distance between the front surface portion and rear surface portion is between one third and three times, preferably between a half and twice, the largest dimension of the largest cross section through the continuous smooth surface.

The “chunky” bulbous shapes of such a handle allow a particularly flexible ergonomic handling, giving many varied gripping positions for the human hand and easy twisting of the handle within the grip to reach different angles. The combination of this chunky shape with the easy release lever allows for a comfortable and safe ejection (and replacement) of cartridges. The lever can be simply actioned with the forefinger alone to eject the razor, with the remaining fingers and thumb comfortably positioned on the handle, away from the blades.

Moreover this shape allows the handle to stand on a surface with the blade and any lubrapad of an attached cartridge suspended above the surface. This can help prevent blade corrosion and adhesion of the shaving aid (lubrapad) to the surface.

The front surface portion may be flat or concave. This front surface may extend to the guard side of the attachment to the blade unit, and may conveniently be provided with a logo and/or instructions. It may extend substantially parallel to the rear surface portion and preferably substantially parallel to a main direction (in terms of longest extent) of the handle connecting structure. The front and/or rear surface portions may extend at a slant to the continuous smooth surface (i.e. at a non-perpendicular angle).

The top surface portion (and underneath surface portion) of the handle may be approximately parallel to the shaving plane in use. In this case, the front and/or rear surface portions extend at a slant to the user's skin. The slant may be back away from the cap, giving improved visibility.

A recess may be provided in the underneath surface portion to receive the handle connecting structure. For example, the handle connecting structure may fit, either permanently or detachably, into an insert housed in the recess. The recess may be of rectangular section, with a direction up into the handle, and may be at the same slant as the front and/or rear surfaces.

The body may have any suitable construction. For example, the body may be solid or contain a hard core or hard hollow core. This may allow the use of a softer material for the body.

In a further definition, the handle may comprise a moulded translucent or transparent body of elastomeric material such as TPE, silicone or rubber having a Shore A hardness of 5 to 65 or preferably 10 to 50; wherein the body has a shape which is rounded and chunky (or bulbous), extending with perpendicular length I, width w and height h, wherein none of the maximum length, width and height of the body is more than 2, 3 or 4 times the size of the maximum in the other two dimensions. For example, the height may be the largest vertical cross section through the continuous smooth surface previously defined, the width may be the largest vertical cross section through the continuous smooth surface and the length may be the horizontal distance (parallel with the shaving plane) between the front surface portion and the rear surface portion.

In a further definition, the handle body may be bulbous in two orthogonal directions, widening away from an end surface towards the centre of the body. Thus an outline/silhouette of the handle body in both these directions may be generally fat and round. As noted earlier, such a “chunky” bulbous shapes are ergonomic.

The handle body may comprise a further end surface opposite to the end surface. The two opposite surfaces may be connected by a side surface which widens towards the centre (or approximate centre) of the body. The opposite further end surface gives an even better handling feel, particularly if there are opposite flat surfaces. Of course, the handle body may widen away from the end surface not just in two orthogonal directions but in many or all of the directions in between these two orthogonal directions, so that the increase in size is general and thus of most of or the entire cross section. The side surface may be a single continuous curved side surface. This curved side surface, or a plurality of curved side surface portions, may provide the handle body with a cross section that increases continuously (without decreasing) away from the flat end surfaces towards the centre of the body, forming the bulbous shape mentioned above. The further end surface may be a front end surface. This surface thus forms the front of the razor in use, facing in the opposite direction to the shaving direction. Correspondingly, the end surface may be a rear end surface facing in the shaving direction in use. The cartridge attachment means may be on the side surface, for example closer to the front end surface than to the rear end surface.

In use, the safety razor is pulled backwards across the skin in the shaving direction. The end surface may therefore be in front of the blades in the shaving direction (to the rear of the razor if the cartridge is seen as the front), and the further end surface behind the blades in the shaving direction (to the front of the razor).

As mentioned above, one or both end surfaces may be flat. The flat end surfaces may be parallel, providing a symmetrical feel which gives the user a better tactile impression of the overall handle, for improved shaving experience. One or both of the flat end surface(s) may be circular or elliptical, for example.

The handle body may be in the form of a slanted barrel shape, with a skewed barrel surface between two end surfaces. The barrel shape may be terminated at either end with a slanted end surface, which is not orthogonal to the barrel axis. Neither is the barrel shape itself necessarily formed from a circle of varying diameter extruded along a central straight axis. Rather, the handle body as a whole may be viewed as having a skewed barrel shape (potentially with a curved barrel axis).

When the two parallel end surfaces are in a vertical orientation, with the handle connecting structure extending downwards, the barrel surface may be skewed/slanted upwards from the front end surface towards the rear end surface.

If the handle connecting structure projects from the side surface and parallel to the end surface, then a slanted/overhang design of the handle (with the end surface(s) extending at a slant (non-perpendicular angle) to the average direction of the side surface between the centres of the two end surfaces) allows the handle body to sit with the rear end surface at the back of the user's hand grip on or towards the palm of the hand, with the user's fingers positioned on the front end surface and side surface. In this position the end surfaces slope up and back towards the user's hand, allowing a better view of the cartridge.

The barrel shape may have a substantially circular or substantially elliptical cross section perpendicular to its longitudinal axis (which may be straight or curved). The barrel shape may widen continuously from the two end surfaces towards the centre. For example, the largest diameter of the barrel shape (which may be central along its axis) may be between a third and three times the length of the longitudinal axis of the barrel, preferably between a half and twice. The largest diameter of the barrel shape may be larger than the length of its longitudinal axis.

The end surface may be provided with a recess or other interface allowing attachment to another part, such as packaging or a travelling case, or suspension from a hook (which could be provided separately) on a wall or other vertical surface.

The handle body may be made of a single part and material (excluding any minor additions of logos etc). In one example it is made of two or more parts, such as a core and an external layer, or two opposite halves, which are fabricated individually, and then connected. The insert may also be connected to form the full body at the same stage.

The handle body may have any suitable construction. The handle body may comprise a single material or may comprise a core material and an outer material. Inserts may be made in the same material or one or more different materials. In one example the handle body is solid or contains a hard core or hard hollow core. This may allow the use of a softer material for the rest of the body.

Another embodiment provides a replaceable blade cartridge, comprising: a blade unit housing a plurality of shaving blades; a frame secured to the blade unit, the frame having a guard in front of the blades and a cap to the rear of the blades; and a cartridge connecting structure comprising a pair of legs extending outwardly from a body and forming a pivoting connection to the blade unit. The ends of the legs may be located within a cavity of the blade unit. As such, the cartridge connecting structure can have a small profile.

Another embodiment provides a safety razor system, comprising: a safety razor handle; a replaceable razor cartridge; and a connection system for connecting the safety razor handle to the replaceable blade cartridge according to any of the definitions above.

The handle body may have a substantially flat end surface and a side surface, the handle connecting structure is attached to the side surface, and when the flat end surface is in contact with a horizontal plane, the safety razor is in a stable position of rest, the flat end surface forming the safety razor's only region of contact with the plane and elevating the cartridge above the plane.

The flat end surface allows the handle to stand on a horizontal plane, such as a basin edge or shelf with the blades and any shaving aid (e.g., lubrapad) of an attached cartridge suspended above the surface and no other point of contact between the safety razor and the horizontal plane. This can help prevent blade corrosion and adhesion of the shaving aid to the surface.

The term “flat” is used herein to describe a surface which is completely or substantially flat and which thus may include some portions which are not flat (and thus some portions which are not in contact with the horizontal plane). For example, the surface may include patterns, a logo, an opening or writing recessed into the flat surface, some surface texturing or curvature or the like. However, the surface may be substantially unbroken. Preferably over 80%, or more preferably over 90% of the surface is in contact with the horizontal plane.

The term “stable position of rest” indicates that the safety razor will stay in the upright position on its flat end surface with the cartridge elevated without any external assistance/force.

The overall handle body shape may be bulbous in two orthogonal directions. Thus an outline/silhouette of the handle body in both directions may be generally fat and round (over the whole extent of the handle body).

The flat end surface and the “chunky” bulbous shapes of the handle allow not just a particularly stable position with the flat end surface on a level counter, but as noted earlier also are ergonomic.

The side surface may be a curved surface (made up of a single surface on several curved surface portions) adjacent to the flat end surface. This can give a good handling feel, with a flat face and possibly also an edge between the flat face and a curved face providing a tangible spatial reference to the user in combination with an easy-grip curved surface.

The handle body may comprise an opposite further end surface, giving even better handling feel. The further end surface may be rounded (concave or convex) and is preferably an opposite flat surface (opposite to the end surface). The side surface may be a single continuous curved side surface (or in fact the rest of the handle body including the opposite end may form a single continuous curved surface). This curved side surface, or a plurality of curved side surface portions, may provide the handle body with a cross section that increases away from the flat end surfaces towards the centre of the body, forming the bulbous shape mentioned above.

The flat end surfaces may be parallel, providing a symmetry which gives the user a better tactile impression of the overall handle, for improved shaving experience. One or both of the flat end surface(s) may be circular or elliptical, for example.

In use, the safety razor is pulled backwards across the skin in the shaving direction. The flat end surface may be in front of the blades in the shaving direction (to the rear of the razor if the cartridge is seen as the front), and the further flat end surface may be behind the blades in the shaving direction (to the front of the razor).

The flat end surface may be of a size which gives good stability to the safety razor when resting on a plane. Thus it may have an area which is larger than the footprint of the cartridge on the skin surface, or preferably an area which is twice or more this size.

In some cases, the handle body is not elongate. For example, the largest extent of the handle body (measured in any direction) may be up to twice the smallest dimension of the flat end surface. In one example, the distance between two parallel flat end surfaces is equal to or smaller than the diameter (or smallest dimension) of one or both flat end surfaces.

In one exemplary construction, the centre of mass of the handle and cartridge is above and vertically within the footprint of the flat end surface on the horizontal plane, and the handle body overhangs the flat end surface to one side when the razor is stably positioned on the flat end surface. This overhang side is preferably the side on which the cartridge is mounted. The cartridge may be mounted closer to the further flat end surface than to the flat end surface (i.e. closer to the front of the razor than to the rear in use, and closer to the top of the razor when stably positioned on the plane). Various different angles of overhang are possible.

The stability of the safety razor on the horizontal plane can be assured in any suitable way. The material of the handle body on the same side of the centre of mass as the overhang may be less dense than the material of the handle body to the other side of the centre of mass from the overhang. For example, there may be a hollowed portion extending in the overhang side, or a lower density material.

Equally, the flat end surface may be provided with an anti-tilting lip on the same side as the overhang. The anti-tilting lip may extend from the end surface on the overhang side.

Any suitable means may be provided to aid stability of the safety razor. For example, the flat end surface may be provided with a suction feature, such as an air opening into a hollow part in a flexible handle body to help retention of contact between the flat end surface and the horizontal plane.

Equally, the flat end surface may be provided with a recess or other interface allowing attachment to another part, such as packaging or a travelling case, or suspension from a hook (which could be provided separately) on a wall or other vertical surface (or the same air opening could be usable for both purposes).

The handle body may be made of a single part and material (excluding any minor additions of logos etc). In one example it is made of two or more parts, such as a core and an external layer, or two opposite halves, which are fabricated individually, and then connected. The insert may also be connected to form the full body at the same stage.

The handle body may have any suitable construction. The handle body may comprises a single material or may comprise a core material and an outer material. Inserts may be made in the same material or one or more different materials. In one example the handle body is solid or contains a hard core or hard hollow core. This may allow the use of a softer material for the rest of the body.

A further definition of a safety razor handle comprises: a handle body with a substantially flat end surface and a side surface; and a cartridge attachment on the side surface, wherein: when the flat end surface is in contact with a horizontal plane, the safety razor is in a stable position of rest, the flat end surface forming the safety razor's only region of contact with the plane and elevating the handle connecting structure above the plane.

Thus not only is the handle connecting structure elevated, so that it allows the handle to be resting in a stable position and the user to easily exchange a cartridge, but any attached cartridge is also elevated. As mentioned previously, the cartridge (and handle connecting structure) may be on the side surface positioned towards the further end surface and thus towards the top of the razor when the razor rests on its end surface.

In any of the handle definitions, the handle body may comprise a single moulded translucent or transparent body (forming a core or hollow core, an outer layer or the full body) of elastomeric material such as silicone, TPU (thermoplastic polyurethane), TPE (thermoplastic elastomer) PETG (Polyethylene Terephthalate Glycol), TPS or rubber (such as liquid silicone rubber or compression silicone rubber) for example having a Shore A hardness of around 5 to 80, preferably a squeezable 20 Shore A under the ASTM D2240-00 testing standard. As used herein, TPEs are thermoplastic elastomers, for example thermoplastic elastomers selected from the group of styrenic block copolymers (TPE-s including TPE SBS and the hydrogenated version of TPE-SEBS; e.g. Thermoplast K, Thermolast M, Sofprene, or Laprene), thermoplastic olefins (TPE-o; e.g. For-Tec E), elastomeric alloys (TPE-v or TPV; e.g. Thermolast A, Thermolast V, Hipex, Forprene, Termoton-V, or Vegaprene), thermoplastic polyurethanes (TPU; e.g. Copec), thermoplastic copolyesters (TPE-E), thermoplastic polyamides and mixtures thereof. As used herein, silicones (or polysiloxanes) are polymers that include any inert, synthetic compound made up of repeating units of siloxane. These materials give a superior tactile feeling with a material that is soft and yet strong due to the shape of the handle. Moreover, the body being translucent or transparent allows the user to gain a better feel of the positioning of the handle (and thus of the attached blade unit) with respect to the hand and to the skin to be shaved.

In any of the handle definitions, the insert between the handle connecting structure and the handle body may be fabricated separately, for example from PPA Polyphthalamide)(/PPS (Polyphenylene sulphide)/LCP (Liquid Crystal Polymer) or ABS (Acrylonitrile Butadiene Styrene). The material may have a glass filling of 0% up to 40%, or 10% to 30%, preferably around 20%. The materials and/or fabrication process may be chosen in such a way that the insert and core material will chemically bond with the handle material. For example, the handle body may be made entirely from a soft transparent silicon and the insert may be made from PPA (Polyphthalamide) with 20% glass filling. In another example, the handle body may made entirely from a soft transparent TPE (thermoplastic elastomer) and the insert may be made from PP (polypropylene) with 20% glass filling. In another example, the handle body external portion is made from a soft transparent TPE (thermoplastic elastomer) and a handle body core and the insert are formed together from a thermoplastic.

The above indicated embodiments may be combined with each other to achieve the advantageous effects as described above. Further embodiments, features, and advantages of the invention, as well as the structure and operation of the various embodiments of the invention are described in detail below with reference to the accompanying drawings.

### DESCRIPTION OF FIGURES

The accompanying drawings, which are incorporated herein and form a part of the specification, illustrate the present invention and, together with the description, further serve to explain the principles of the invention and to enable a person skilled in the pertinent art to make and use the invention.

Reference will now be made to FIGS. 1 to 34, in which:

FIG. 1 is a side view of a safety razor standing upright on its flat end surface on a horizontal plane;

FIG. 2 is a side view of the safety razor shown in FIG. 1 in a use position;

FIG. 3 is a front view of the safety razor shown in FIG. 1 in a use position;

FIG. 4 is a perspective view from the side and underneath of the safety razor shown in FIG. 1 in an upright position;

FIG. 5 is a perspective view from directly underneath of the safety razor shown in FIG. 1 in an upright position;

FIG. 6 are perspective views from above of the safety razor shown in FIG. 1 in a use position;

FIG. 7 is a side view from above of the safety razor shown in FIG. 1 in a use position;

FIG. 8 is a photograph in side view of a safety razor in a use position;

FIGS. 9a to 9c show the safety razor of FIG. 1 with preferable dimensions in millimeters;

FIG. 10 is a perspective in-use view of a handle and cartridge with a lubrapad from the top side (user side);

FIG. 11 is a side view of the handle and cartridge with lubrapad of FIG. 10;

FIG. 12 is another perspective view of the handle, blade unit and lubrapad of FIG. 10, but from the front;

FIG. 13 is another perspective view of the handle and cartridge with lubrapad of FIG. 10, but from underneath (skin side);

FIG. 14 is a front view from underneath of the handle and cartridge with lubrapad of FIG. 10;

FIG. 15 is a rear view of the handle and blade unit with lubrapad of FIG. 10;

FIG. 16 is a perspective view of a handle and cartridge in a use position with lubrapad demonstrating the translucent material of the handle;

FIG. 17 is a perspective view of a safety razor in use under the arm;

FIG. 18 is a perspective view of a safety razor in use on the shin;

FIG. 19 is a perspective front view from above of a safety razor including a connection system, in a connected state;

FIG. 20 is a perspective front view from above of the safety razor including the connection system shown in FIG. 18, in a disconnected state;

FIG. 21 is a perspective front view of a razor cartridge and a cartridge connecting structure shown in FIGS. 19 and 20, in a disassembled state;

FIG. 22 is a front view of the razor cartridge and cartridge connector structure shown in FIG. 21, in an assembled state;

FIGS. 23a and 23b are cross-sectional side views of the razor cartridge and cartridge connecting structure shown in FIG. 22, in an assembled state, showing pivoting of the cartridge connecting structure relative to the cartridge;

FIG. 24 is a perspective view from the side and underneath of the handle body and handle connecting structure shown in FIG. 20, in a disassembled state;

FIG. 25 is a perspective view from the side of the handle body and handle connecting structure shown in FIG. 24, in an assembled state;

FIG. 26 is a cross-sectional perspective front view from above of the handle body and handle connecting structure shown in FIG. 25;

FIG. 27 is a cross-sectional front view of the handle body and handle connecting structure shown in FIG. 25;

FIG. 28 shows top and cross-sectional front views of the handle connecting structure and the cartridge connecting structure, in an engaged state;

FIGS. 29a, 29b and 29c are a sequence of cross-sectional side views of the handle connecting structure and the cartridge connecting structure shown in FIG. 28, showing the engagement;

FIG. 30 is a perspective front view from above of the cartridge connecting structure;

FIG. 31 is a perspective front view from above of part of the handle connecting structure with the handle insert;

FIG. 32 is a perspective front view from above of the handle connecting structure with the handle insert;

FIGS. 33, 34 and 35 are cross-sectional side views of different ways of securing the handle connecting structure to the cartridge connecting structure;

FIG. 36 is a top view of the handle connecting structure;

FIGS. 37 and 38 are cross-sectional side views of the handle connecting structure shown in FIG. 36;

FIG. 39 is a perspective front view from above of the handle connecting structure shown in FIG. 36;

FIG. 40 is an exploded view of the handle connecting structure shown in FIG. 36;

FIG. 41 is a cross-sectional front view of the handle connecting structure and the cartridge connecting structure;

FIG. 42 is a perspective front view of the lever;

FIGS. 43a, 43b, 43c and 43d are a sequence of cross-sectional side views of the handle connecting structure and the cartridge connecting structure, showing the disengagement;

FIGS. 44a, 44b, 44c and 44d are another sequence of cross-sectional side views of the handle connecting structure and the cartridge connecting structure, showing the disengagement;

FIGS. 45a, 45b, 45c and 45d are a sequence of cross-sectional front views of the handle connecting structure and the cartridge connecting structure, showing the disengagement;

FIGS. 46a and 46b show the forces applied to the cartridge connecting structure by the lever of the handle connecting structure, when disengaging;

FIGS. 47a, 47b, 47c and 47d are a sequence of cross-sectional side views of the handle connecting structure and the cartridge connecting structure, showing the disengagement, according to another embodiment;

FIG. 48 shows the forces applied to the cartridge connecting structure by the lever of the handle connecting structure, when disengaging, according to another embodiment;

FIGS. 49a, 49b, 49c and 49d are a sequence of cross-sectional side views of the handle connecting structure and the cartridge connecting structure, showing the disengagement, according to another embodiment;

FIG. 50 shows the forces applied to the cartridge connecting structure by the lever of the handle connecting structure, when disengaging, according to another embodiment;

FIG. 51 is a cross-sectional view of the lever according to another embodiment;

FIGS. 52a, 52b, 52c and 52d are a sequence of cross-sectional side views of the handle connecting structure and the cartridge connecting structure, showing the movement of the lever during the engagement;

FIGS. 53a and 53b are cross-sectional side views of the handle connecting structure and the cartridge connecting structure, the movement the lever can make when the cartridge connecting structure is not engaged;

FIGS. 54 and 55 are perspective views of alternative embodiments of the lever;

FIGS. 56 and 57 are cross-sectional front views of the lever shown in FIGS. 54 and 55, respectively;

FIGS. 58 and 59 are cross-sectional front views of the alternative embodiments of the handle connecting structure and the cartridge connecting structure;

FIG. 60 is a perspective front view of a razor cartridge and a cartridge connecting structure, in a disassembled state;

FIG. 61 is a perspective front view from above of a part of the handle connecting structure and the cartridge connecting structure, according to an alternative embodiment;

FIGS. 62 and 63 are views from above and from the side of the handle connecting structure part shown in FIG. 61;

FIG. 64 is a perspective front view from above of a connection system that can be employed in a safety razor with another handle body design, in a connected state; and

FIG. 65 is a perspective front view from above of the connection system shown in

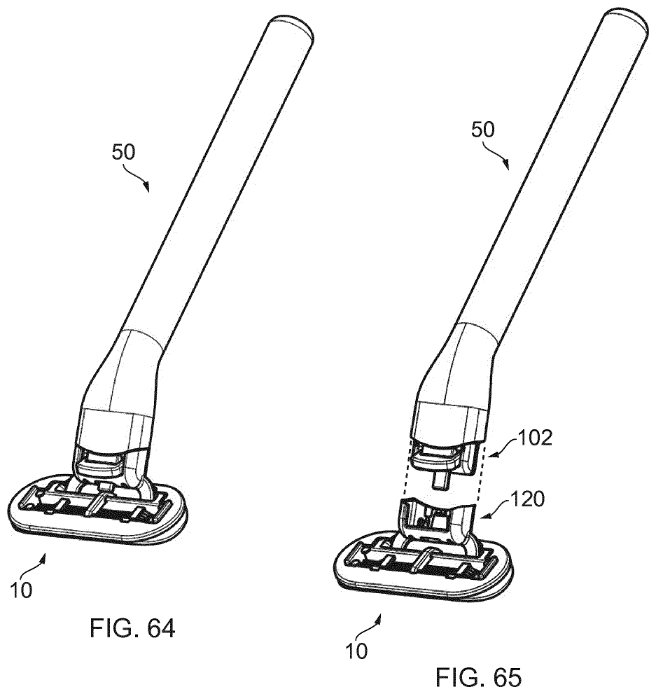

FIG. 64, in a disconnected state.

### DETAILED DESCRIPTION

The following detailed description refers to the accompanying drawings that illustrate examples and embodiments consistent with this invention. Other embodiments are possible, and modifications can be made to the embodiments within the spirit and scope of the invention. Therefore, the detailed description is not meant to limit the invention.

The term “underneath” is used to describe features of the handle, cartridge or a lubrapad that are positioned on the skin-contacting side of the cartridge or lubrapad (i.e., on a shaving-side or underneath of the handle, cartridge or lubrapad) in use, and the term “top” is used to describe features of the handle, cartridge or lubrapad that are positioned on a side opposite the skin-contacting side of the cartridge or lubrapad in use (i.e., on a user side or on top of the cartridge or lubrapad). The terms “front”, “rear”, and “side(s)” are used herein with reference to the shaving direction, i.e., the direction in which the cartridge and lubrapad are intended to be moved during shaving. In particular, the term “front” means facing in the shaving direction, “rear” means facing in the opposite direction to the shaving direction, and “side(s)” mean to either side in the shaving direction. In general, the cartridge is positioned at the front of the razor in use and the razor is pulled backwards across the skin (with the cartridge last).

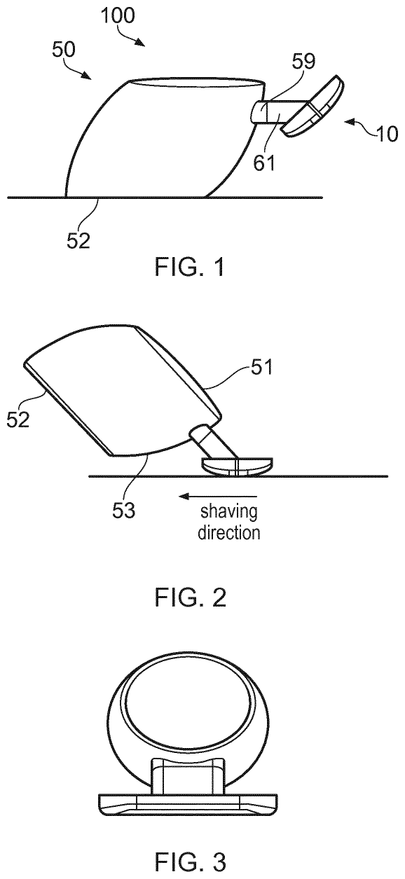

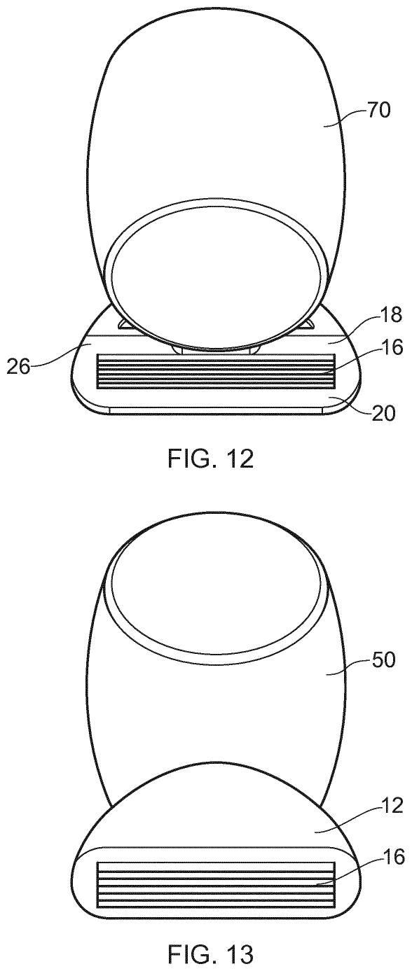

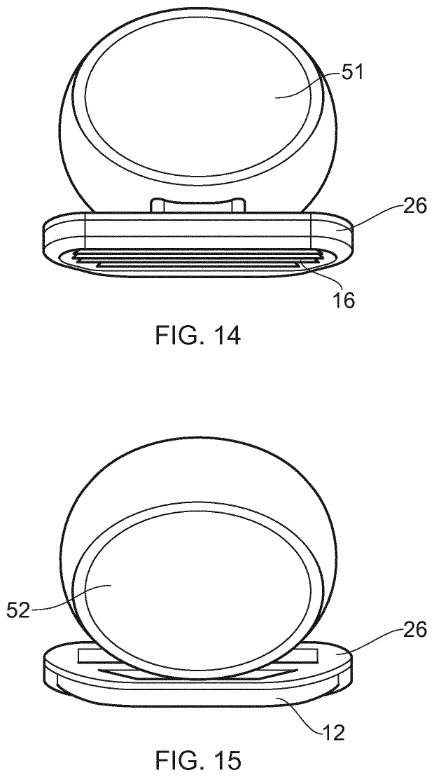

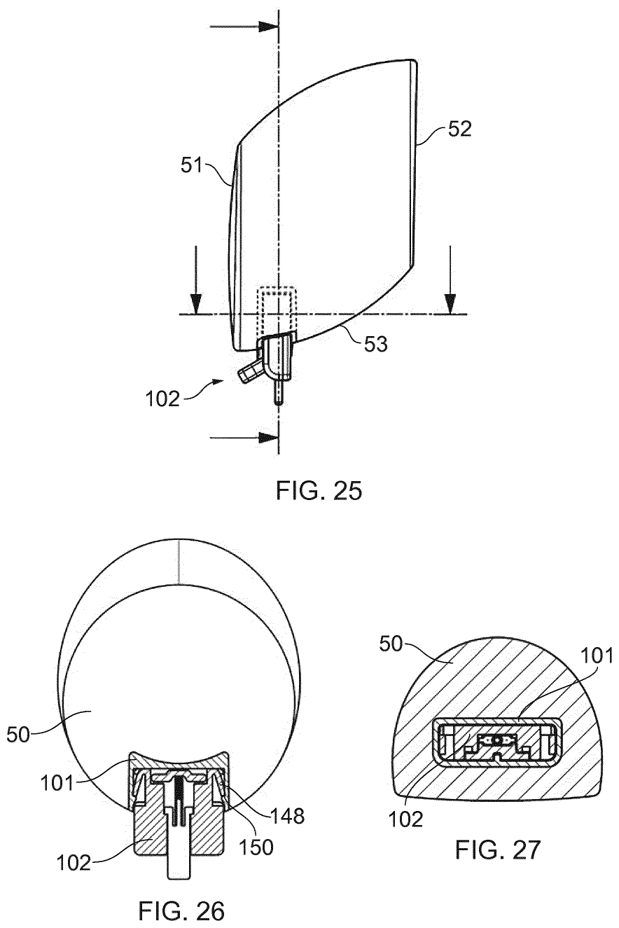

Reference will now be made to FIGS. 1 to 34, which are views of a cartridge 10 and handle body 50 joined by a stem 59, 61. Generally speaking, the described examples can be differentiated from one another in terms of the handle body 50, which can be of different shapes and constructions and the connection of the handle to the cartridge.

FIGS. 1 to 9 show different views of a handle body 50 of rounded, chunky design attached to a cartridge 10.

The handle body has a flat end surface 52 on which it can rest stably upright on a (substantially) horizontal surface, as shown in FIG. 1. In this orientation, the flat end surface rests on the horizontal plane and thus forms an underneath surface, and the further end surface forms a top surface of the razor. Here, the in-use definitions of directions set out for the general case above do not apply. The handle includes the handle body and a handle stem or cartridge attachment means 59. When the handle body is upright in its position of rest on a plane, the attachment means 59 which is provided on the side surface of the handle body towards the top surface is elevated above the plane. This elevates the cartridge itself above the plane, since the lowest point of the cartridge (the guard) is only slightly below the attachment means.

When the razor is in use, the flat end surface forms the rear surface of the razor, as shown in FIG. 2.

Opposite to the flat end surface is a further flat end surface 51. This is a front surface portion when the razor is in use, as shown in FIG. 2, and in the upright resting position is at the top, as previously mentioned. Any of the surfaces of the handle body, but particularly the front surface in use may be provided with information, logos, or other signs and patterns. Such a logo, for example, may have a different surface texture (gloss or matt or rough, for example) from the surrounding material, be protruded or recessed from the surrounding material or have a combination of finish and relief. If the handle body is made from more than one material, the combination of materials (for example using cut-outs or embossing) may be used to distinguish the logo.

These two opposite surfaces are parallel, and are separated by a single continuous side surface 56. As can be seen clearly from FIG. 6, this side surface is approximately barrel-shaped and bulbous, with a chunky form that expands from the end surfaces towards the centre of the handle body. The barrel shape is terminated at either end with a slanted end surface, which is not orthogonal to the barrel axis. Neither is the barrel shape itself formed from a circle of varying diameter extruded along a central straight axis. Rather, the handle body as a whole may be viewed as having a skewed barrel shape (with a curved barrel axis as shown in FIG. 1). The skewed barrel shape gives a visual effect, for example, of a deformed barrel shape which is produced when a flexible, “jelly” material attached on its circular barrel end surface to a horizontal supporting plane is skewed laterally and parallel to the end surface by movement of the top (or further end) surface.

The side surface of the handle body 56 has a curved underneath portion 53, a curved top portion 54 and curved lateral portions 55 in use as shown in FIGS. 5 and 6. A handle stem 59 extends from the curved underneath portion of the handle body parallel to the end surfaces. The curved surface portions together form a continuous smooth curved surface which is substantially circular or ellipsoid in cross section, but may vary in shape and size along its length between the front and rear of the handle.

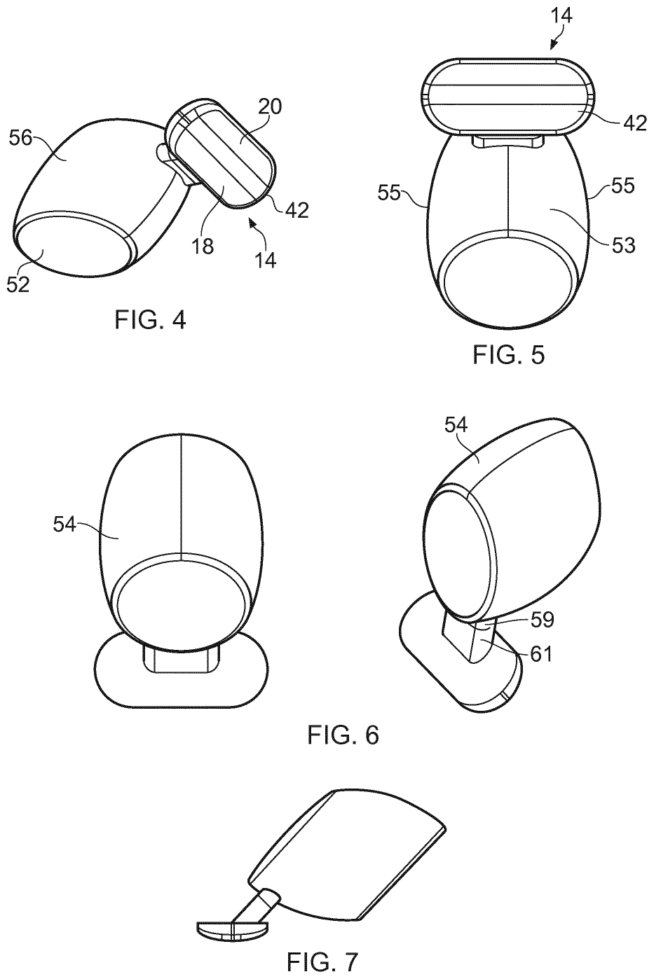

As shown best in FIG. 4, the cartridge 10 includes a guard 18, a cap 20, and rounded side portions 42 that together define a blade housing 14 within which a plurality of blades 16 (not shown) are disposed. The number of blades 16 can be, for example, four or five, though it can be fewer or more than this. The guard 18 is in front of the blades 16 in the shaving direction and the cap 20 is to the rear of the blades 16. The cartridge 10 can be connected to the handle body 50, either fixedly or detachably by connection between the handle stem 59 and a cartridge stem 61 (see FIG. 7). For example, cooperating means (not shown) on the handle stem and cartridge stem may provide a clipped, spring-loaded connection which can be unclipped using a moving part (not shown) which is contacted by the user to attach and/or detach the handle body and cartridge.

FIGS. 4 and 5 show the cartridge footprint on the user's skin, with its parallel sides and rounded edges to each end of the blades. The area of the footprint can be measured by projecting the skin-contacting edges of the cartridge onto a flat plane.

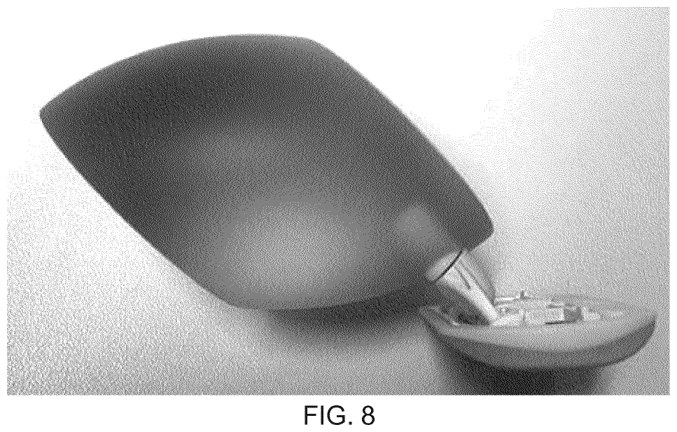

The handle body is made entirely from a translucent silicone or TPE-SEBS in this example, as can be seen better in FIG. 8. The material is translucent and light coloured, so light can easily transmit through it. The translucent material is not only attractive but also practical in allowing parts behind the body to be glimpsed through the body and thus aiding user orientation and shaving performance. The surface looks and feels silky and non-sticky to the hands of the user. FIG. 8 also reveals the extension of the handle stem 59 into the body. The stem and any other interface part may be made of a harder plastic, such as PPA/PPS/LCP or ABS.

The handle body may be formed by either LSR or injection or compression moulding. The full razor may weigh around 40 to 60 grams, preferably around 55 grams and the handle body may have a Shore A hardness of approximately 10 to 50, preferably 15 to 40 or around 20, to give a squeezable feel and pleasurable tactile sensation when gripped by the user. It may include a logo on the front surface (the further end surface which is on the top when the razor is in the upright position).

The stem may be fixedly connected to the handle body, such as by chemical connection.

In other examples, the handle body may have a hollow or solid insert (such as a core) of another material. If there is a hollow insert, it may store a fluid, such as a shaving preparation. In this case, the stem between the cartridge and handle body may include a fluid passage for a shaving preparation dispensed from within the body and the body may include a dispensing aperture.

The cartridge of these figures may include a lubricating strip or wider lubrapad 12 (not shown) as an additional or integral part of the cartridge, for example with a single frame both surrounding the blades and providing a back support for the lubrapad. The end surface has been shown and described as flat, but may alternatively be curved or uneven, if there is no requirement for the razor to be stable in an upright position.

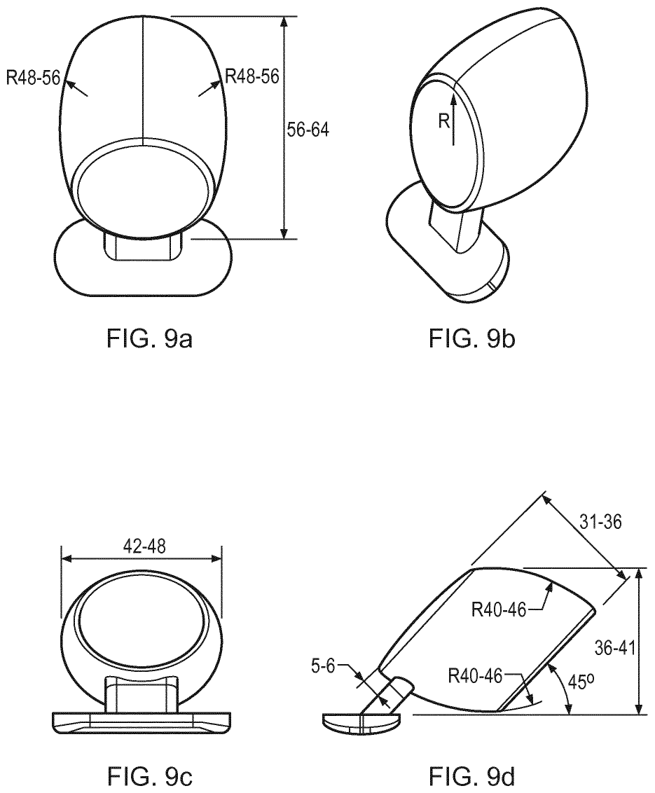

Some advantageous dimensions of the safety razor which give good manoeuvrability in the human hand are shown in FIGS. 9a, 9b, 9c and 9d. The maximum radius of curvature of the “skewed barrel shape” side surface may range between 35 and 75 mm, preferably 48 and 56 mm, for example 53 mm. The radius of curvature of the skewed barrel shape at the barrel ends is between 30 and 55 mm, preferably between 40 and 4 6mm, for example 44 mm. The radius of the flat surfaces (measured along the surfaces, rather than perpendicular to the barrel surface) is slightly smaller.

The maximum length of the handle body parallel to the skin surface in use (with the end surface at 45° to the skin surface) is from 40 to 80 mm, preferably between 56 and 64 mm, for example 61 mm. This is measured from the foremost extent of the front (the lowest portion of the front or further end surface) to the rearmost extent of the rear (the highest portion of the rear or end surface which rests on the horizontal plane when the razor is upright). The maximum height of the handle body in use is between 25 and 55 mm, preferably between 36 and 41 mm, for example 39 mm.

The distance between the end surfaces is between 25 and 45 mm, preferably between 31 and 36 mm, for example 35 mm. The handle stem (or other interface between the handle and cartridge) starts at 3 to 10, preferably 5 to 6 mm along the underneath portion of the side surface in use from the front surface. The maximum width of the handle body measured parallel to the end surfaces is between 35 and 60 mm, preferably between 42 and 48 mm, for example 46 mm.

If the cartridge is flat on the skin in use, the end surfaces extend at between 35 to 55, preferably at 45 degrees to the skin surface.

The cartridge footprint may have a length of around 25-60 mm in the blade direction, preferably around 40-50 mm and a depth orthogonal to the blade direction from the front to the rear of the cartridge of around 10-30 mm, preferably 15-23 mm. Whilst the cartridge size may have a natural maximum linked to its function, the handle body and in particular the handle body extent in the blade direction is not similarly limited.

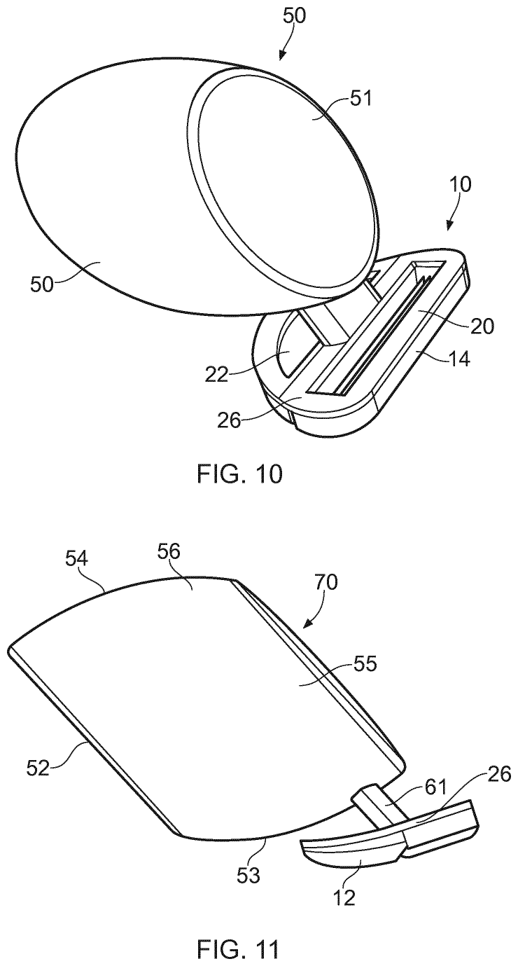

FIGS. 10 to 15 show slightly different cartridge construction, but the same general handle body shape, with like reference numerals labelling the same parts as for FIGS. 1 to 9. Therefore, the reader is directed to the previous description thereof.

FIGS. 10 to 15 show lubrapad 12, and blades 16 in the blade housing 14. The cartridge 10 of these figures includes the lubrapad 12 as an integral part, with a single frame 26 surrounding the blades 16 and providing a back support for the lubrapad 12.

In an alternative definition which can be applied to these figures and the earlier and later figures, some examples of the invention provide a safety razor handle comprising: an underneath surface portion 53 facing the skin of the user in use and comprising an attachment means (such as a stem 61) for attachment to a blade unit; a front surface portion 51 facing in the opposite direction from the shaving direction in use; a rear surface portion 52 facing in the shaving direction in use; a top surface portion 54 and lateral surface portions 55, one directed to either side of the blade length in use; wherein the top surface portion, underneath surface portion and side surface portions together form a continuous smooth surface which is a substantially cylindrical or substantially ellipsoid or substantially partially spherical surface; and wherein: the distance between the front surface portion and rear surface portion is between one third and three times, preferably between a half and twice, the largest dimension of the largest cross section through the continuous smooth surface.

The term substantially cylindrical or substantially ellipsoid or substantially partially spherical surface is used to describe a shape which is close to cylindrical or ellipsoid or partially spherical form, for example with a 10% deviation from one of those forms. In one measure, a section (or all sections) taken vertically through the continuous smooth surface (for example in a direction parallel to the blade length) overlaps with a circle or ellipse drawn to just cover the whole section with the areas of the circle or ellipse which are not covered by the section being up to one tenth of the area of the section.

The front and rear surface portions may be flat or concave. The front surface may extend to the guard side of the attachment to the blade unit, and may conveniently be provided with a logo and/or instructions. It may extend substantially parallel to the rear surface portion and preferably substantially parallel to a main direction (in terms of longest extent) of the stem.

In another embodiment the body is hollow and contains a shaving preparation, which, for example, can be squeezed out by the user via the attachment means to the blade unit. Thus the shaving preparation (which may contain lubricating and/or hair conditioner and/or moisturiser) may pass through the recess, for example within a part of the blade unit which is housed inside the recess.

In one razor embodiment, the attachment means for attachment to the blade unit and corresponding means on the blade unit allow relative movement, such as pivoting movement, between the handle and the blade unit. For example the connection between the corresponding means and attachment means may have some play, or one or both of the attachment means or corresponding means may be flexible.

In one embodiment the corresponding means is a stem extending from the blade unit to the handle. The stem may fit into the recess, permanently or detachably.

In a further embodiment, the razor comprises a hard shell extending from the stem and forming part of the handle. The hard shell may give additional support to the body and enable an enhanced connection to the blade unit.

In one embodiment either the stem or the shell is provided with a spigot (outlet for fluid connection from the body) which extends into the handle, to transport shaving preparation.

In one embodiment the shell forms the rear surface portion and part of the underneath and side surface portions of the handle. In this case, the shell may fit over the elastomeric material (such as TPE, rubber or silicone) body described previously. It may fit into receded surface portions of the body, so that the combination of the shell and the body provides a smooth external surface.

In one embodiment the safety razor further comprises a lubrapad. For example, a lubrapad body may be provided adjacent to the blade unit, and extend along a guard of the blade unit and in front of the guard in use. The lubrapad body may have a greatest width and/or depth in the blade direction at the guard, the body width and/or depth reducing in a smooth convex curve away from the guard to a curved front portion of the body.

In one embodiment the lubrapad body and cartridge are provided separately and comprise attachment means to attach them together whilst allowing relative movement, such as flexible projections from a front surface of the guard, which are to be housed in recesses in a surface portion of the lubrapad body which is directly facing the guard front surface.

In a further definition of the handle, invention embodiments provide a safety razor handle comprising a moulded translucent or transparent body of elastomeric material such as TPE, silicone or rubber having a Shore A hardness of 5 to 65 or preferably 10 to 50; wherein the body has a shape which is rounded and chunky (or bulbous), extending with perpendicular length l, width w and height h, wherein none of the maximum length, width and height of the body is more than 2, 3 or 4 times the size of the maximum in the other two dimensions.

For example, the height may be the largest vertical cross section through the side smooth surface previously defined, the width may be the largest horizontal cross section through the side surface and the length may be the horizontal distance (parallel with the shaving plane) between the end surfaces.

Any of the previous features of the handle and safety razor (and safety razor system) may be applied to these embodiments.

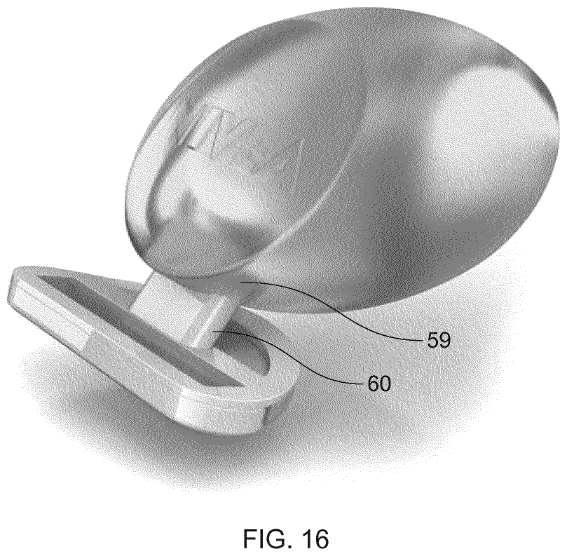

FIG. 16 shows a safety razor with the cartridge construction of FIGS. 10 to 15 and made of a translucent silicone or TPE. This razor has a non-flat “dished” (gently concave) front surface with an embossed logo.

The composition of the lubrapads described herein can include a gliding agent. Materials which may be selected as the gliding agent are: PEG-400/1,4-Butanediol/SMDI Copolymer, PEG-115M, PEG 45M, and PEG-5M, or a combination thereof. The composition of the lubrapad can include an antioxidant agent, for example Tocopherol. The composition of the lubrapad can include an anti-inflammatory agent, for example aloe barbadensis leaf juice. The composition of the lubrapad can include a backbone structure. Materials which may be selected as the backbone structure are: styrenic block copolymers and polystyrene, or a combination thereof.

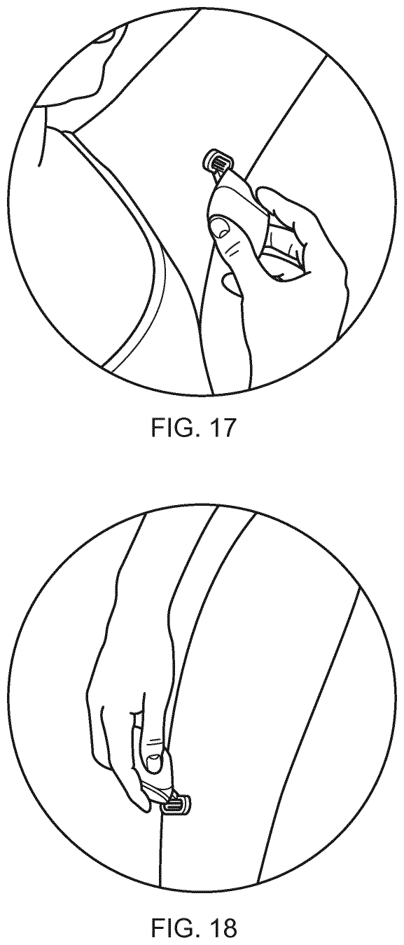

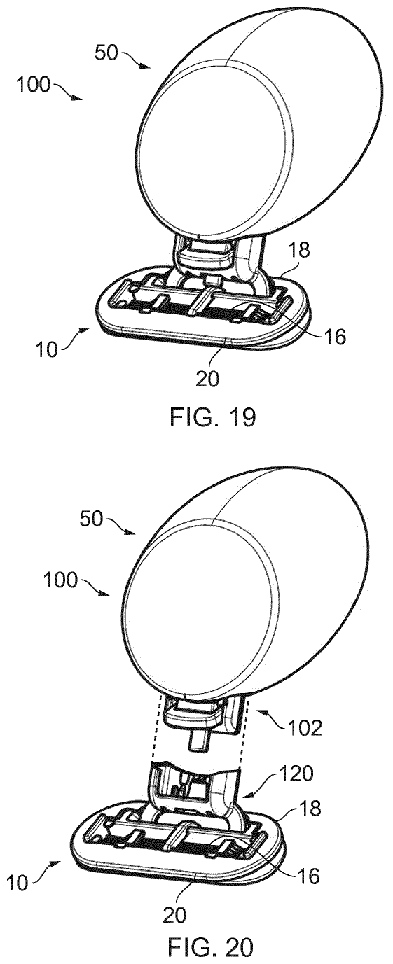

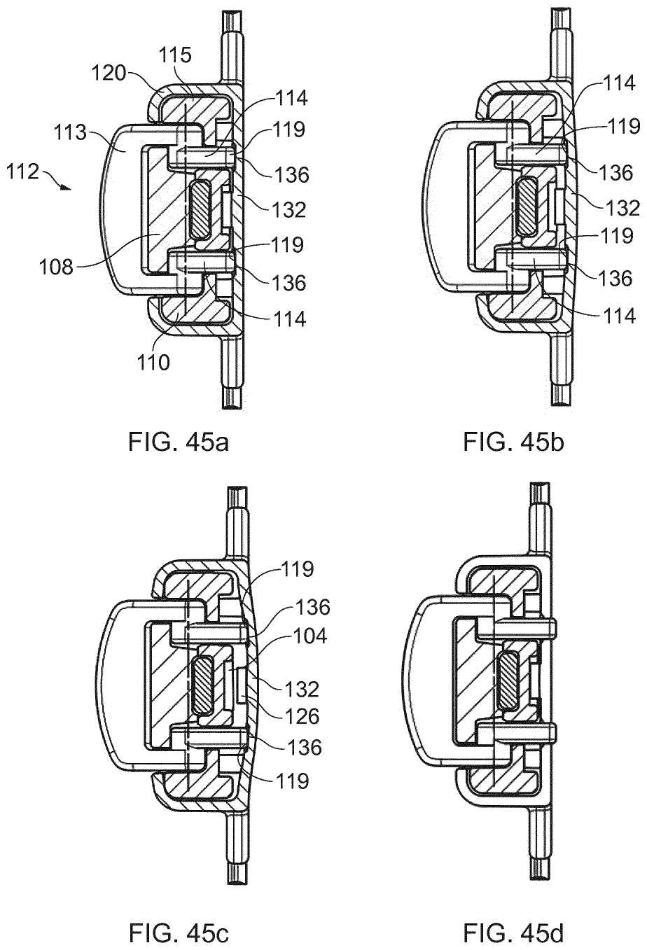

Reference will now be made to FIGS. 19 to 63, which show various embodiments of a connection system for releasably connecting a razor cartridge to a safety razor handle such as that described with reference to FIGS. 1 to 18.

FIG. 19 shows a safety razor 10 with a handle 50 in a connected state with a replaceable cartridge 10 that has a guard 18, a cap 20, and a plurality of blades 16 between the guard 18 and the cap 20. FIG. 20 shows the safety razor 10 of FIG. 19 in a disconnected state. The connected and disconnected states are achieved by means of a connection system that comprises a handle connecting structure 102 attached to the handle 50 and a cartridge connecting structure 120 attached to the cartridge 10. Generally speaking, the connection system shown in FIGS. 19 to 63 replaces the handle stem 59 and cartridge stem 61 shown in FIGS. 1 to 18.

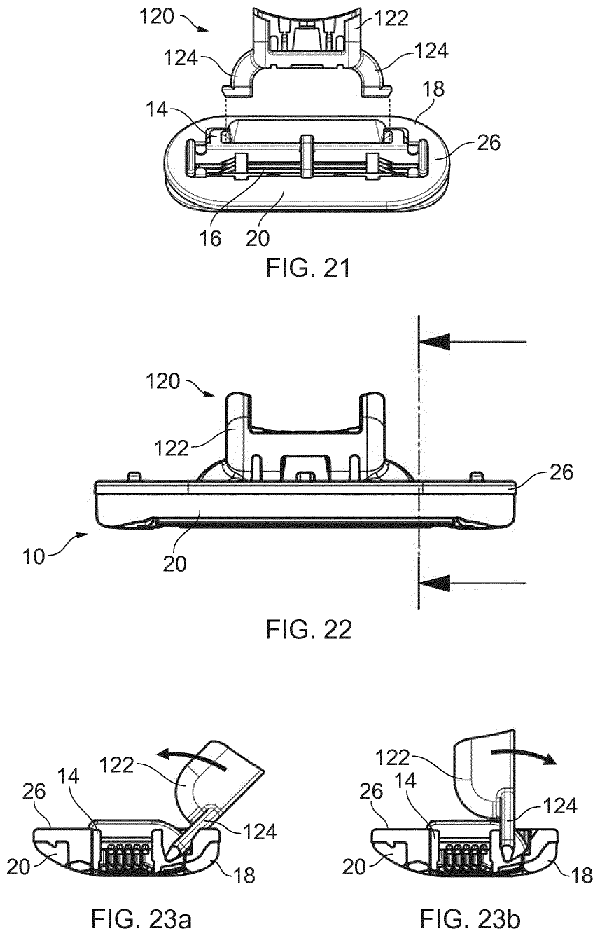

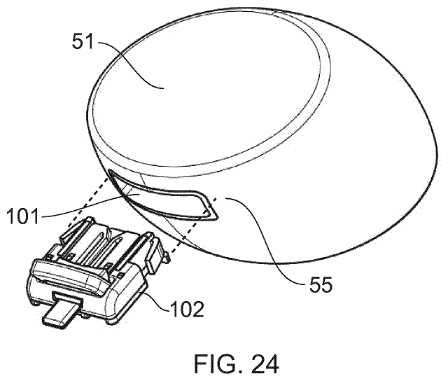

FIGS. 21, 22, 23a and 23b show examples of how the cartridge connecting structure 120 can be attached to the cartridge 10, while FIGS. 24 to 27 show examples of how the handle connecting structure 102 is attached to the handle 50.

As can be seen in FIG. 21, the cartridge connecting structure 120 comprises a pair of legs 124 extending outwardly from a body 122 to form a pivoting connection to the blade unit 14 of the replaceable blade cartridge 10. The cartridge connecting structure 120 can be constructed to permit some inward flex of the legs 124 (i.e., towards each other), thereby enabling a snap-fit connection with recesses provided in the blade housing 14 of the cartridge 10. The blade housing 14 is secured to a frame 26 that defines a perimeter of the cartrdige 10. As can be seen in FIGS. 23a and 23b, which are cross-sectional side views of FIG. 22, the cartridge connecting structure 120 allows relative pivoting of the cartridge 10 of about 45 degrees. The pivoting angle is determined by the contact of the arms 124 against portions of the frame 26 of the cartridge 10. Other pivoting angles, in the range of for example 35 to 55 degrees, are also possible of course, or even no pivoting at all.

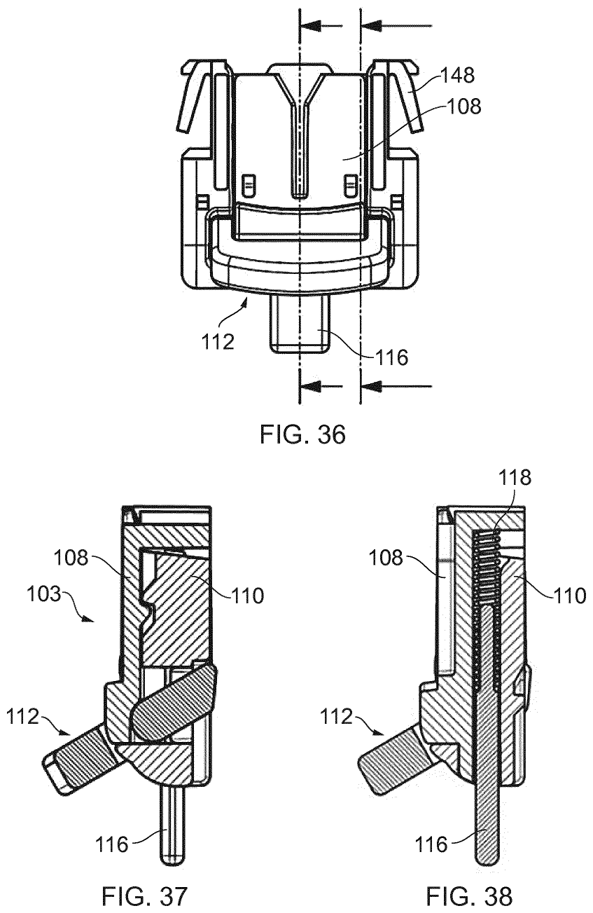

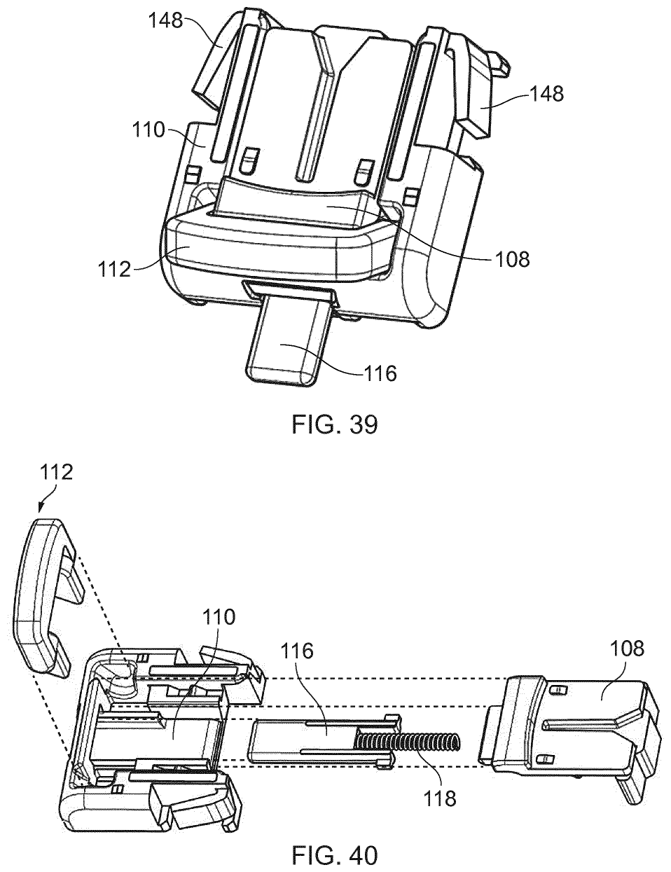

Referring now to FIGS. 24 to 27, an insert 101 is disposed in a recess in the underneath surface portion 53 of the handle body 50. As noted earlier the handle body may comprise a single moulded translucent or transparent body of elastomeric material. The handle may be overmoulded around the insert 101. The insert 101 can be made of plastic to provide a ‘solid’ supporting structure in which the handle connecting structure 102 can be positioned. As shown in FIG. 26 (and visible in more detail in FIGS. 36 and 39), the handle connecting structure 102 has a pair of hook-shaped retaining elements 148 which form a snap-fit connection with corresponding protrusions 150 provided on the insert 101. However, the handle connecting structure 120 may be attached to the handle body by other mechanical means, or by non-mechanical means such as by gluing.

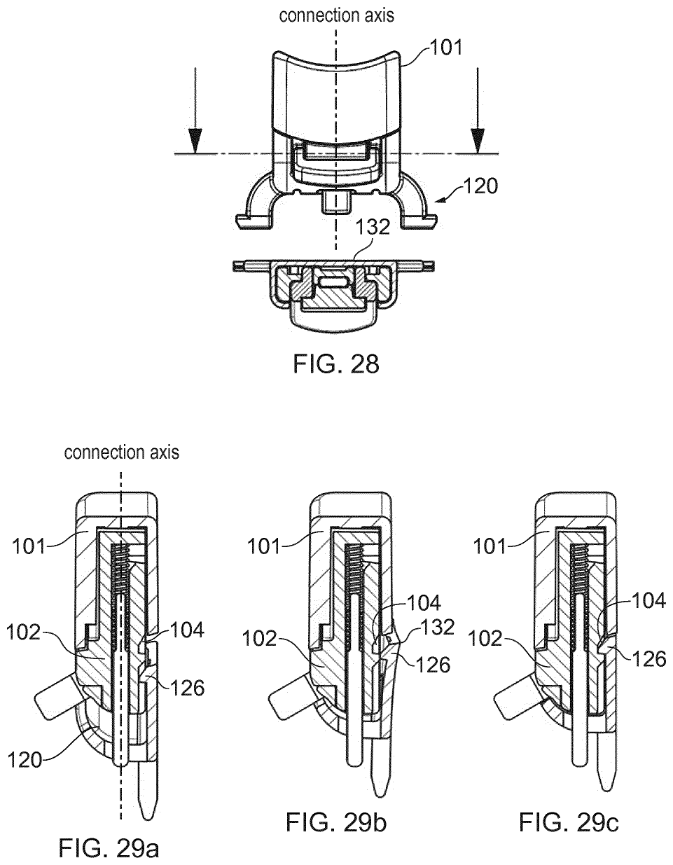

FIGS. 28 to 32 show examples of how the connecting structures 102, 120 can be engaged to each other.

As shown in the upper part of FIG. 28, in the connected state between the cartridge connecting structure 120 and the handle connecting structure 102, the body of the cartridge connecting structure 120 is slid over the handle connecting structure 102 along a connection axis up to a lower edge of the handle insert 101. Of note in the lower part of FIG. 28 is that in the connected state the back wall 132 of the cartridge connecting structure 120 is not deformed and is flat. Also in this state, the contact surfaces 119, visible in FIG. 42, of the working end 114 of the lever 112 are generally in parallel with a longitudinal direction of the handle connecting structure 102, i.e., generally in parallel with the connection axis. The term “along the connection axis” includes configurations which are parallel to the connection axis as well as configurations which are slightly offset from parallel. Similarly, the term “away from the connection axis” includes configurations which are perpendicular to the connection axis as well as configurations which are slightly offset from perpendicular.

As shown in FIG. 29a, when the cartridge connecting structure 120 and the handle connecting structure 102 are initially brought into engagement along the connection axis, the securing element 126 of the cartridge connecting structure 120 moves through a lead-in channel 106 located on the bottom of the handle connecting structure 102.

The lead-in channel 106 is best seen in FIG. 31, which shows the handle connecting structure 102 and insert 101 from underneath. In this particular example, the securing element 126 of the cartridge connecting structure 120 is a latch that forms one part of a snap-fit connection (the other part being a recess 104 formed on the handle connecting structure 102). As shown in FIG. 29b, at the top of the lead-in channel 106, the securing element 126 of the cartridge connecting structure 120 meets a ramp 154, which forces the securing element 126 outwards. This causes deformation of the rear wall 132 of the cartridge connecting structure 120. Upon further movement the cartridge connecting structure 120 reaches the connected state and, as shown in FIG. 29c, the securing element 126 will spring back into the recess 104. This secures the cartridge connecting structure 120 to the handle connecting structure 102 (and thus the cartridge 10 to the handle 50). Complementary positioning features 130 on the cartridge connecting structure 120 and the handle connecting structure 102, e.g., protrusions and recesses may be implemented to minimize ‘play’ between the connecting structures 102, 120.

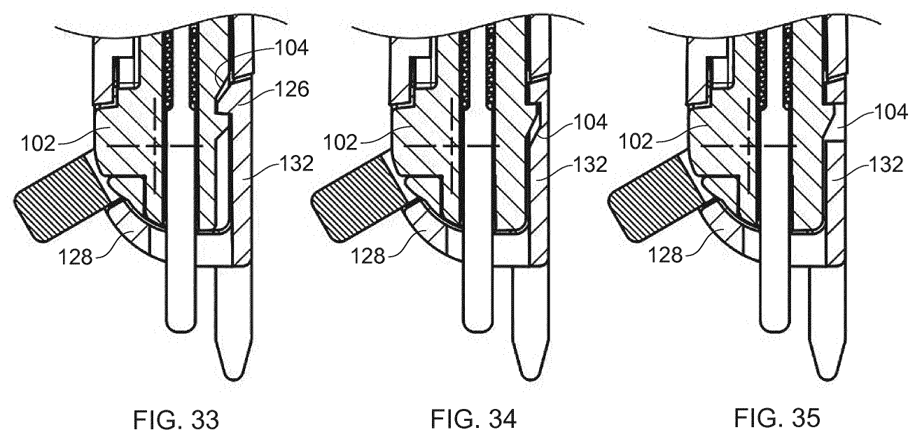

FIGS. 34 to 35 show alternative configurations for the securing elements of the cartridge and handle connecting structures 102, 120. For comparison purposes, the configuration just described is shown in FIG. 33. As shown in FIG. 34, the recess 104 can instead be located on the rear wall 132 of the cartridge connecting structure 120. Alternatively, as shown in FIG. 35, the recess 104 can be implemented as a cut-out through the full thickness of the rear wall 132.

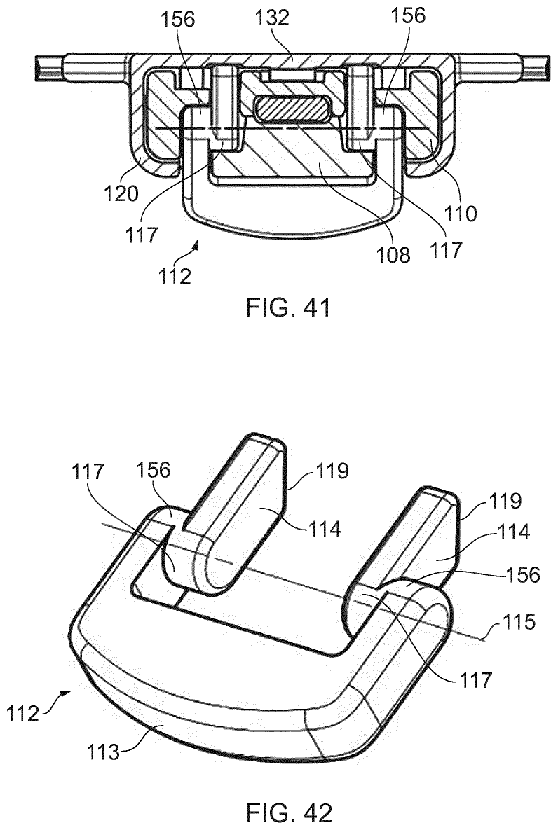

With reference now to FIGS. 36 to 42, the handle connecting structure 102 comprises a lever 112 mounted to a body 103. Specifically, the body 103 comprises a housing 110 and a cover 108, between which the lever 112 is sandwiched. The lever 112 has a user end 113 and a working end 114. The working end 114 comprises a pair of arms. Each arm has a contact portion comprising a contact surface 119, and a bearing portion comprising a bearing surface 117. The working end 114 is attached to the user end 117 along the rotation axis 115. The user end 113 is C- or U-shaped and has bearing surfaces 156 which face in an opposite direction to the bearing surfaces 117 of the working end. As can be seen in FIG. 41, the bearing surfaces 117 of the working end 114 bear against the inner surface of the cover 108 and the bearing surfaces 156 of the user end 113 bear against an inner surface of the housing 110. This distributes the load experienced by the handle connecting structure 102 due to rotation of the lever 112 across multiple of surfaces. As can be seen in FIGS. 37 and 41, the working end of the lever is generally in line with the bottom of the housing 100.

The handle connecting structure 102 may also include a plunger 116 that, in use, is biased by a spring 118 against a surface of the cartridge 10. This is shown in FIG. 19. During shaving the cartridge can follow the contours of the skin, following which the cartridge is biased to its rest position. The plunger 116 has small protrusions on the spring end to retain it in the handle connecting structure 102. Also visible in FIGS. 36 and 39 are the spring-like arms 148 which fasten the handle connecting structure to the insert (see FIG. 26).

The lever 112 performs two main functions. First, it functions to release the securing elements 104, 126 that hold the cartridge connecting structure 120 to the handle connecting structure 102. Second, it functions to eject the cartridge connecting structure 102 from the handle connecting structure 120. These functions are related in that they each occur when the lever 112 is actuated (rotated) by the user, although the degree to which each function is performed may vary as the lever 112 is actuated. For example, initial rotation of the lever 112 may result in the release of the securing elements 104, 126 (also referred to below as the ‘release phase’), and further rotation of the lever 112 may result in ejection of the cartridge connecting structure 120 from the handle connecting structure 102 (referred to below as the ‘ejection phase’). The boundary between the end of the release phase and the start of the ejection phase may be defined in terms of the start of the movement of the cartridge connecting structure 102 away from the handle connecting structure 102 along the connection axis. However, it will be appreciated that the release and ejection phases are not necessarily discrete, due to the configuration in which the lever 112 interacts with the cartridge connecting structure 120 to perform both functions. Of course, configurations are possible in which the lever 112 may perform the function of ejecting the cartridge connecting structure 120 from the handle connecting structure 102 but not the function of releasing the securing elements 104, 126, for example if an independent release mechanism for the securing elements 104, 126 is provided.

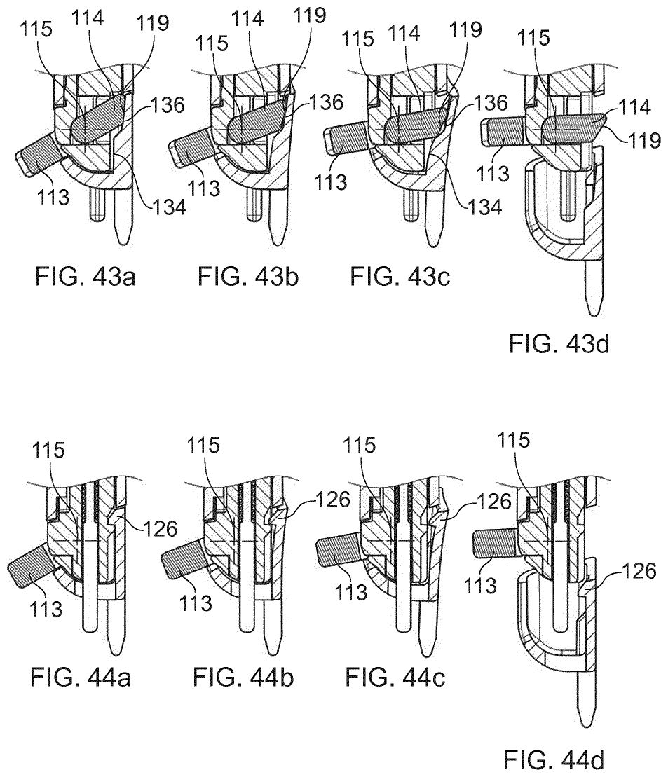

The aforementioned release and ejection phases will now be described with reference to FIGS. 43 to 46.

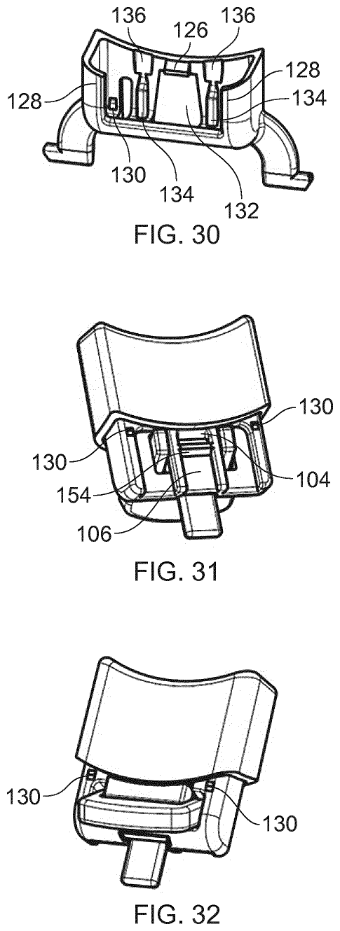

FIGS. 43a, 44a, and 45a show the state of the connection system prior to actuation of the lever 112. At the start of the release phase, shown in FIGS. 43c, 44c, and 45c, the lever 112 begins its rotation around the rotation axis 115, which results in the working end (arms) 114 of the lever 112 extending, or further extending, from the underside of the body 103 of the handle connecting structure 102. The contact surfaces 119 of the working end 114 of the lever 112 push onto the cartridge connecting structure 120, and more specifically onto push faces 136 provided on an inner surface of the rear wall 132 of the cartridge connecting structure 120 (best seen in FIG. 30). This causes deformation of the rear wall 132 of the cartridge connecting structure 120, and the securing element 104 of the cartridge connecting structure 120 to start releasing the complementary securing element 126 of the handle connecting structure 102. For example, in the case of a snap-fit connection the deformation results in the latch 126 moving out of the recess 104. As shown in FIGS. 43c, 44c, and 45c, at a given deformation the securing element 104 of the cartridge connecting structure 120 is fully released and the cartridge connecting structure 120 is no longer secured to the handle connecting structure 102.

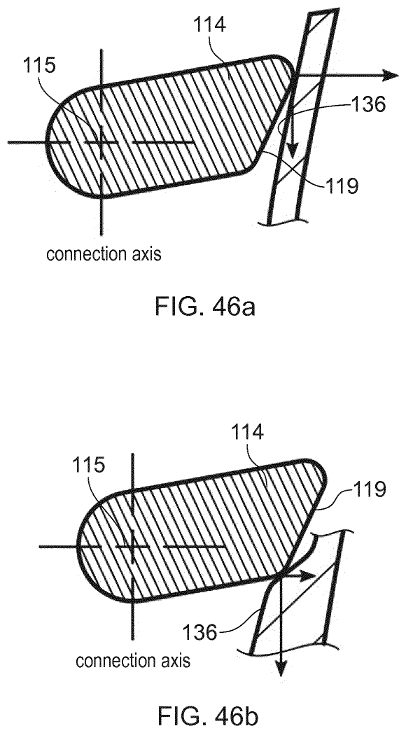

In the ejection phase, due to the deformation of the back wall 132 of the cartridge connecting structure 120, the back wall 132 is angled relative to the release direction of the cartridge 10 as best seen in FIG. 43c. Tension between the tips of the working end 114 of the lever 112 and the back wall 132 of the cartridge connecting structure 120 creates a force parallel to the release direction of the cartridge 10. This is represented by FIG. 46a by the arrow parallel to the release axis. There is also a force component in the direction perpendicular to the release axis which is represented by the second arrow. Additionally, at some point during the rotation of the lever 112 and subsequent deformation of the cartridge connecting structure 120, the tips of the working end 114 of the lever will touch and push onto the push ribs 134 of the cartridge connecting structure 120 (seen in FIGS. 30, 43a and 43c). This also results in a force parallel to the release direction. This is represented by FIG. 46b by the arrow parallel to the release axis. There is also a component in the direction perpendicular to the release axis which is represented by the second arrow. The relative size of the arrows are intended to indicate the relative magnitude of the forces, and may not be exact indications of the actual force. When the securing elements 104, 126 of the connecting structures 102, 120 are released, the combination of the two forces parallel to the release direction will cause the cartridge connecting structure 120 (and the rest of the cartridge 10) to ‘spring off’ (to be ejected from) the handle connecting structure 102. As shown in FIGS. 43d, 44d, and 45d, once the cartridge connecting structure 120 has moved away from the lever 112, sufficient clearance is available between the cartridge connecting structure 120 and the handle connecting structure 102 to not restrict the further movement of the cartridge connecting structure 120 (and the rest of the cartridge 10). Accordingly, the lever 112 has rotated from an inclined orientation relative to the connection direction towards an upright (perpendicular) orientation relative to the connection axis during the release and ejection phases.

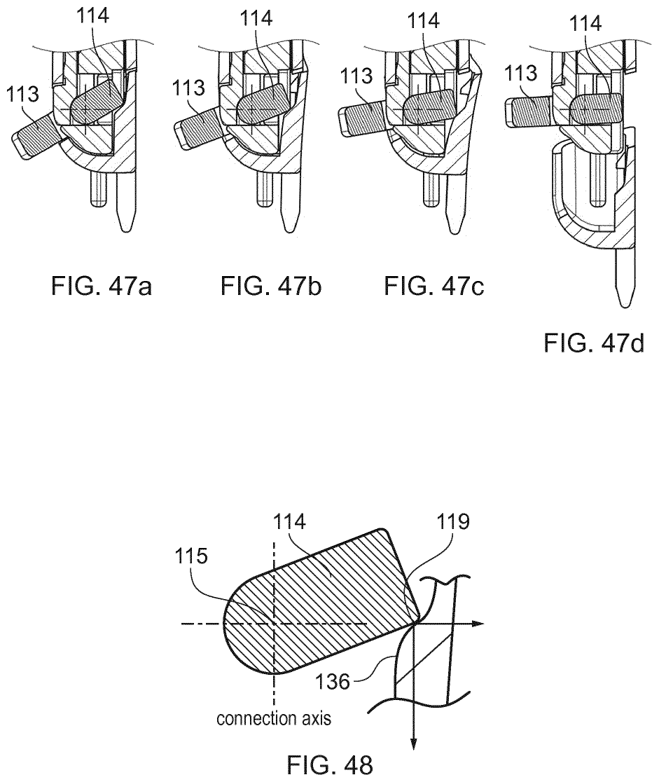

FIGS. 47 to 50 show alternative possible configurations of the release lever 112 and the rear wall 132 of the cartridge connecting structure 120.

In the configuration shown in FIGS. 47 and 48, an alternative configuration is to not use the rear wall of the cartridge connecting structure 120 directly. As shown in FIGS. 47a-d and 48, the release lever 112 can have a flat contact surface rather than a chamfered contact surface as shown in FIGS. 43 and 46. The bottom of the tips of the lever push onto the protrusions (ribs) of the cartridge connecting structure 120. This results in a force perpendicular to the back wall of the cartridge connecting structure 120, which in turn causes deformation of the cartridge connecting structure 120 and subsequent release of the snap-fit connection. Additionally it also results in a force parallel to the release direction, which causes the cartridge connecting structure 120 to spring/eject of the handle connecting structure 102 when the snap-fit is fully released.

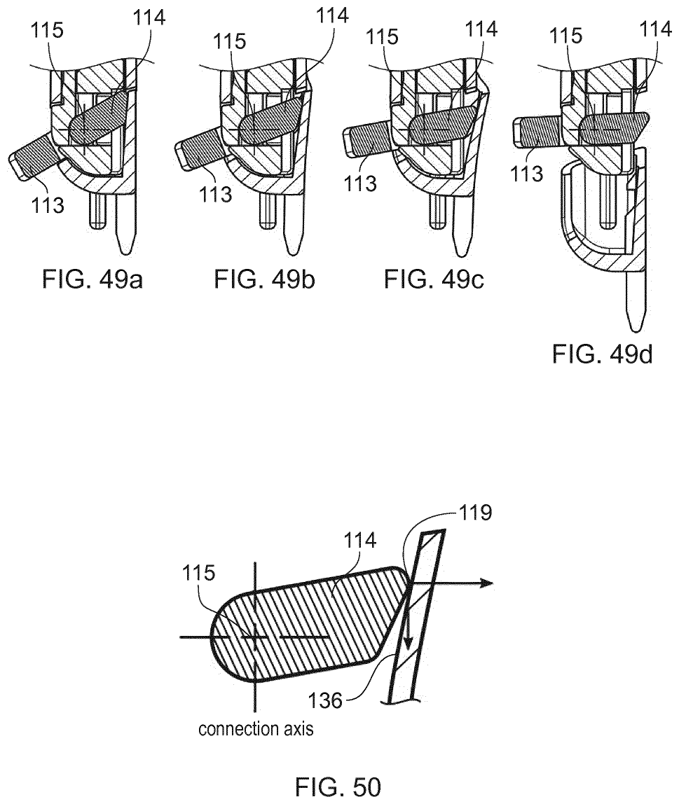

In an alternative configuration shown in FIGS. 49 and 50, the cartridge connecting structure 120 does not have the aforementioned protrusions (ribs). The bottom of the tips of the lever 112 push directly onto surfaces (push faces) of the rear wall 132 and only that wall. This results in a force perpendicular to the rear wall 132 of the cartridge connecting structure 120, which cause deformation of the cartridge connecting structure 120 and subsequent release of the snap-fit connection. Additionally it also results in a force parallel to the release direction, which causes the cartridge connecting structure 120 to spring/eject off the handle connecting structure 102 when the snap-fit is fully released.

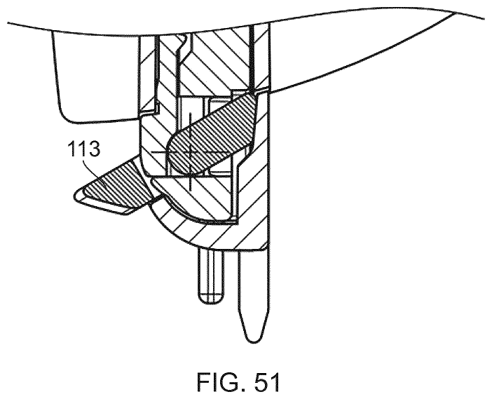

An alternative configuration for a lever 112 is shown in FIG. 51. Here, the user end 113 of the lever 112 is shaped in such a way that it doesn't have a top face. Such a chamfered surface guides the user towards proper use of the lever 112 by inviting the user to rotate the user end 113 towards the handle instead of, for example, attempting to push the lever downwards (perpendicular to connection axis/bearing axis) as if it were a push button. Thus, the top surface invites and allows the user to push on the top of it.

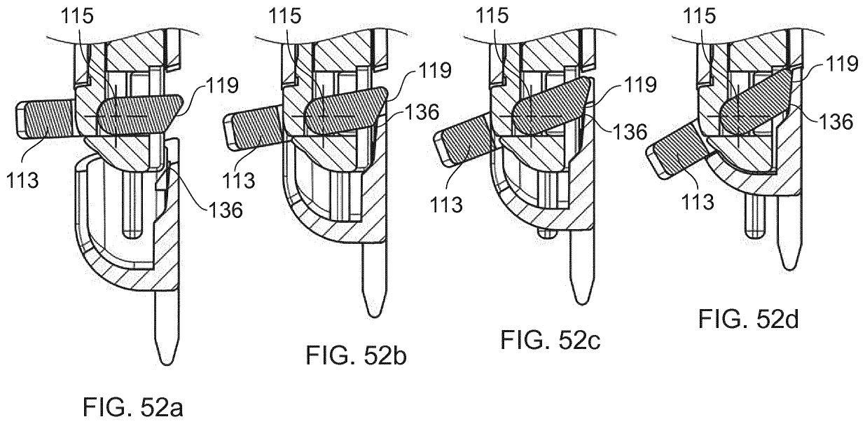

FIGS. 52a-d show how the lever 112 can be returned to its ‘ready’ position after a cartridge 10 has been ejected and a new cartridge 10 is attached to the handle 50. In particular, the shape of the lever 112 and the position of the the rotation axis 115 allows the lever to be pushed back to its connected position when the pivot-part is moved onto the connector. As shown in FIGS. 52b and 52c, when the cartridge connecting structure 120 is connected to the handle connecting structure 102, the contact surface 119 of the lever 112 is pushed by the rear wall of the cartridge connecting structure 120 to rotate the lever in an opposite direction from rotation by the user. As can be seen in FIG. 52d, the free rotation of the lever is restricted by a cut-out portion at the front of the cartridge connecting structure 120 and the push faces located on the rear wall 136 of the cartridge connecting structure 120.

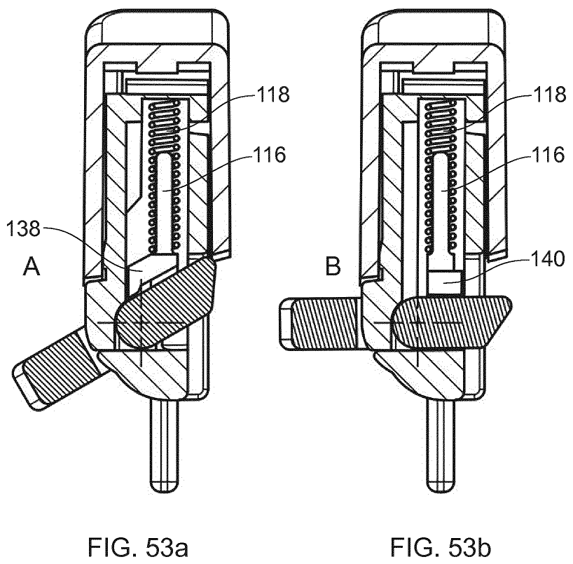

Further configurations will now be described with reference to FIGS. 53 to 63.

FIGS. 53a and 53b show two configurations in which a return element 138, 140 are added to the biasing plunger 116 to force the lever 112 into a defined position when the cartridge assembly is disconnected from the handle assembly. In these figures, a resilient member, in this case a compression spring 118, pushes the biasing plunger 116 towards the front of the handle connecting structure 120 (the part of the handle connecting structure 120 that first engages with the cartridge connecting structure 102), so that the biasing plunger 116 protrudes from the front of the handle connecting structure 120. As shown in FIG. 53a, the plunger 116 includes a feature 118 that is biased by the compression spring 118 against the lever 112 above the rotation axis.

This forces the lever 112 to rotate to an inclined position that corresponds to the ‘ready’ position of the lever 112 when the cartridge connecting structure 102 is connected to the handle connecting structure 120. Alternatively, as shown in FIG. 53b, the plunger includes a feature 140 that is biased by the compression spring 118 below the rotation axis the lever 112. This force the lever 112 into an upright position.

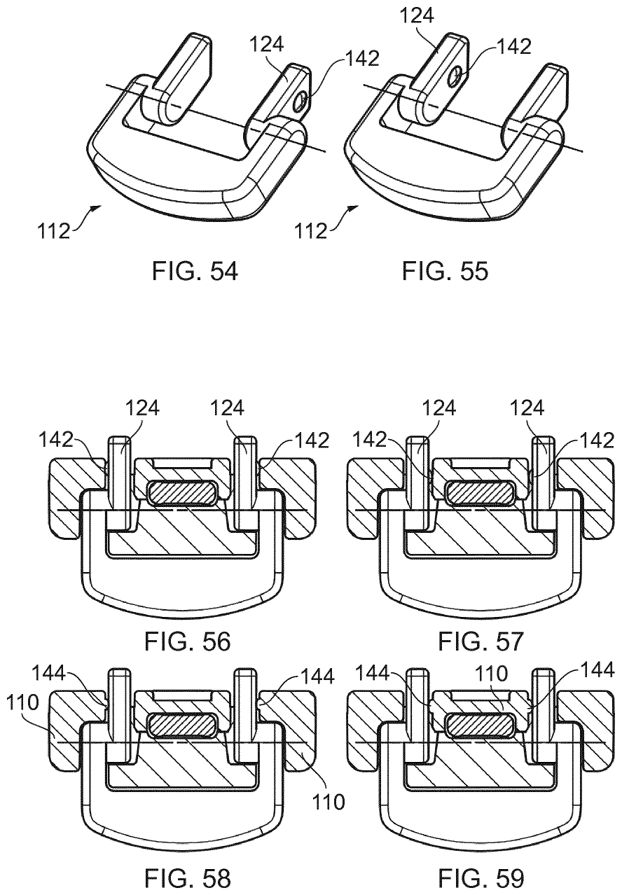

Turning now to FIGS. 54 to 59, features (e.g. domes) 142 can be located on the arms of the lever (either on the outside as shown in FIGS. 54 and 56, or on the inside as shown in FIGS. 55 and 57) to create a predefined amount of friction with the cut-outs in the connector housing. This prevents free movement of the lever. Protrusions 144 such as ribs can be located cut-outs in the connector housing 110 (either on the outside relative to the arms 124 of the lever, as shown in FIG. 58, or on the inside of the arms 124 of the lever, as shown in FIG. 59) to create a predefined amount of friction with the arms 124 of the lever 112. This minimizes or prevents free movement of the lever.

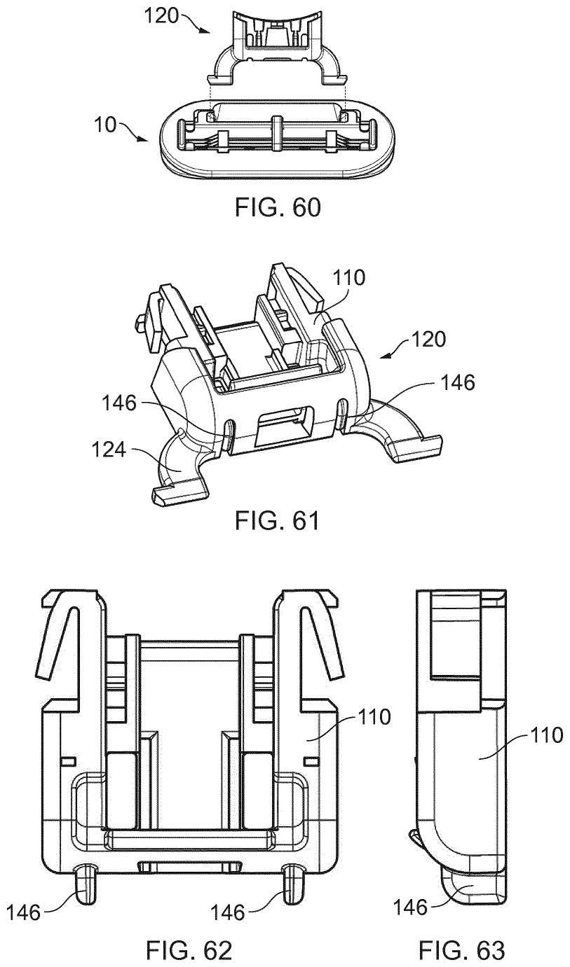

FIG. 60 again shows the cartridge connecting structure 120 and the replaceable blade cartridge 10. FIGS. 61 to 63 show the connectoring structures 102, 120 in a connected state. Features 146 (ribs) can be added to the connector that block the deformation of the pivot when connected. This allows for easy deformation of the pivot when snapping it into the cartridge during assembly. However when the cartridge is connected to the handle, the rib will block/limit deformation of the pivot and inward movement of the leg 124. Therefore dramatically increasing the force at which the cartridge may accidentally snap off the pivot (e.g.) during a drop. Therefore increasing robustness.

FIGS. 64 and 65 show that the connector system described above with reference to FIGS. 19 to 63 can be employed with shaving handles having other shapes. In this particular case, the shaving handles are elongate.

The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

### REFERENCE NUMBERS

10 cartridge

12 lubrapad

14 blade housing

16 blades

18 guard

20 cap

22 lubrapad body

24 front portion (of the lubrapad body)

26 frame

34 projections

36 recesses

38 first surface portion (of the lubrapad body)

40 front surface (of the guard)

42 rounded side portions (of the cartridge)

44 second surface portion (of the lubrapad body)

46 third surface portion (of the lubrapad body)

50 handle body

51 front surface portion or opposite end surface

52 rear surface portion or flat end surface

53 underneath surface portion

54 top surface portion

55 lateral surface portion

56 continuous side surface

57 suction feature

58 handle body recess

59 handle stem/cartridge attachment means

61 cartridge stem

70 moulded body

80 hard shell

81 spigot

82 receded portions of body

83 dispensing aperture

100 safety razor or safety razor system

101 insert for handle connecting structure

102 handle connecting structure

103 handle connecting structure body

104 recess

106 lead-in channel

108 cover of handle connecting structure body

110 housing of handle connecting structure body

112 release lever

113 user portion

114 working portion

115 rotation axis

116 biasing plunger

117 bearing surface of lever

118 biasing spring

119 contact surface or edge

120 cartridge connecting structure

122 housing of cartridge connecting structure

124 legs of cartridge connecting structure

126 snap

128 front wall of housing

130 positioning feature

132 back wall of housing

134 push rib

136 push face

138 return element

140 return element

142 domes

144 ribs

146 ribs

148 hook-shaped elements

150 protrusions

154 ramp

156 bearing surface of user end

1.-20. (canceled)

21. A connection system for connecting a safety razor handle to a replaceable blade cartridge, wherein the system comprises:
a cartridge connecting structure attached to the replaceable blade cartridge; and
a handle connecting structure attached to the safety razor handle and configured to be brought into engagement with the cartridge connecting structure along a connection axis, and wherein
the handle connecting structure comprises a lever mounted to a body, the lever having a user end to be actuated by a user, a working end, and a rotation axis about which the lever is rotatable with respect to the body, the rotation axis being situated between the user end and the working end, and
the working end of the lever is configured to exert a pushing force on the cartridge connecting structure when the lever is rotated by actuation of the user end, to eject the cartridge connecting structure from the handle connecting structure.

22. The connection system of claim 21, wherein the pushing force on the cartridge connecting structure releases complementary securing elements of the handle and cartridge connecting structures.

23. The connection system of claim 21, wherein an inner surface of the cartridge connecting structure comprises a protrusion against which the working end of the lever urges when the lever is rotated by actuation of the user end.

24. The connection system of claim 21, wherein the pushing force deforms a wall of the cartridge connecting structure.

25. The connection system of claim 21, wherein the lever is mounted to the body so that the user end is to be actuated in a direction toward the handle.

26. The connection system of claim 21, wherein the working end of the lever has a chamfered surface.

27. The connection system of claim 21, wherein the working end of the lever comprises a pair of arms, each arm having a contact portion with a contact surface, and each arm being joined to the user end of the lever at the rotation axis.

28. The connection system of claim 27, wherein each arm further has a bearing portion with a bearing surface, and the user end has bearing portions which are respectively joined to the bearing portions of the working end at the rotation axis, the bearing portions of the user end having bearing surfaces which face in a direction opposite to the bearing surfaces of the working end.

29. The connection system of claim 21, wherein bearing portions of the user end and bearing portions of the working end are sandwiched between a housing and a cover of the body, the bearing surfaces of the user end being configured to bear against an inner surface of the housing, and the bearing surfaces of the working end being configured to bear against an inner surface of the cover.

30. The connection system of claim 21, wherein the working end of the lever is configured to contact the cartridge connecting structure when the cartridge connecting structure is brought into engagement with the handle connecting structure, to rotate the lever into a position ready for actuation by a user.

31. The connection system of claim 21, wherein the lever comprises one or more protrusions configured to generate friction against the body of the handle connecting structure.

32. The connection system of claim 21, wherein the cartridge connecting structure comprises a pair of legs extending outwardly from a body and forming a pivoting connection to a blade unit of the replaceable blade cartridge, the body of the cartridge connecting structure comprising a pair of holes adjacent to the pair of legs and configured to receive a pair of protrusions extending from the body of the handle connecting structure.

33. The connection system of claim 21, wherein the user end has a chamfered surface.

34. A handle connecting structure for a safety razor handle, wherein the structure comprises:
a body configured to be attached to the safety razor handle; and
a lever mounted to the body, the lever having a user end to be actuated by a user, a working end, and a rotation axis about which the lever is rotatable with respect to the body, the rotation axis being situated between the user end and the working end, and wherein
when the handle connecting structure is engaged with a cartridge connecting structure of a replaceable blade cartridge and the lever is rotated by actuation of the user end, the working end of the lever is configured to exert a pushing force on the cartridge connecting structure to eject the cartridge connecting structure from the handle connecting structure.

35. A safety razor handle, wherein the handle comprises:
a handle body; and
the handle connecting structure of claim 34.

36. The safety razor handle of claim 35, wherein the handle body comprises:
an underneath surface portion facing a skin of a user in use and comprising an attachment element for attachment to a blade unit;
a front surface portion facing in a direction opposite from a shaving direction in use;
a rear surface portion facing in the shaving direction in use;
a top surface portion and side surface portions, one directed to either side of a blade length in use;
the top surface portion, underneath the surface portion and side surface portions together forming a continuous smooth surface which is a substantially cylindrical or substantially ellipsoid or substantially partially spherical surface; and
a distance between the front surface portion and a rear surface portion being between one third and three times the largest dimension of a largest cross section through a continuous smooth surface.

37. The safety razor handle of claim 35, wherein the handle body is bulbous in two orthogonal directions, widening away from an end surface towards a center of the body.

38. A replaceable blade cartridge, wherein the cartridge comprises:
a blade unit housing a plurality of shaving blades;
a frame secured to the blade unit, the frame having a guard in front of the blades and a cap to the rear of the blades; and
a cartridge connecting structure comprising a pair of legs extending outwardly from a body and forming a pivoting connection to the blade unit.

39. A safety razor system, wherein the system comprises:
a safety razor handle;
a replaceable razor cartridge; and
the connection system for connecting the safety razor handle to the replaceable blade cartridge of claim 21.

40. The safety razor system of claim 39, wherein the handle body comprises a substantially flat end surface and a side surface, the handle connecting structure is attached to the side surface, and when the flat end surface is in contact with a horizontal plane, the safety razor is in a stable position of rest, the flat end surface forming the safety razor's only region of contact with the horizontal plane and elevating the cartridge above the horizontal plane.
